(19) United States
(12) Patent Application Publication
(10) Pub. No.: US 2026/0145251 A1
(43) Pub. Date: May 28, 2026

(54) PORTABLE CUTTING DEVICE FOR CUTTING METAL AND PORTABLE CUTTING DEVICE

(71) Applicant: MAKITA CORPORATION, Anjo-shi (JP)

(72) Inventors: Masaki MURAKAMI, Anjo-shi (JP); Yohei OGINO, Anjo-shi (JP)

(73) Assignee: MAKITA CORPORATION, Anjo-shi (JP)

(21) Appl. No.: 19/177,964

(22) Filed: Apr. 14, 2025

(30) Foreign Application Priority Data
Jun. 6, 2024 (JP) 2024-092138
Jun. 6, 2024 (JP) 2024-092140

(51) Int. Cl. B23D 59/00; B23D 45/16

(52) U.S. Cl. CPC B23D 59/0062; B23D 45/16

(57) ABSTRACT

A portable cutting device for cutting metal has a cutting device main body and a dust box which can be attached to and detached from the cutting device main body. A cutting blade is rotatably attached to the cutting device main body of the cutting device. The dust box has a first housing, a second housing, and an inner plate. The first housing is made of synthetic resin with a first side surface that is positioned inside of the cutting device body. The second housing is made of synthetic resin with a second side surface that is positioned opposite to the first side surface and interconnected with the first housing. The inner plate is arranged through the second side surface and an air layer.

### CROSS-REFERENCE TO RELATED APPLICATION

This application claims priority to Japanese patent application serial number 2024-092138, filed on Jun. 6, 2024, and to Japanese patent application serial number 2024-092140, filed on Jun. 6, 2024, the contents of which are incorporated herein by reference in their entirety for all purposes.

### TECHNICAL FIELD

The present disclosure generally relates to a portable cutting device for cutting metal used for cutting and processing metal materials such as steel. Also, the present disclosure relates to a portable cutting device used for cutting and processing, for example, siding boards, plaster boards, and wooden material. Furthermore, the present disclosure relates to a stand for portable cutting devices which can be used as a stationary cutting device, in which a portable cutting device such as, for example, a metal cutter is mounted on the stand.

### BACKGROUND

For example, a portable cutting device for cutting metal, which is often referred to as a metal cutter, includes a rotatable disk-shaped cutting blade used for cutting metal. When the cutting blade rotates and the portable cutting device moves along the cutting area of a workpiece, the cutting blade cuts the workpiece. Sparks are generated at the cutting area of the workpiece which the cutting blade cuts into. The sparks become heated cutting dusts as their temperature decreases. Various countermeasures are provided in the portable cutting device to prevent the sparks and cutting dusts from scattering into the surrounding environment. For example, the sparks and cutting dusts blow in the rotating wind caused by rotation of the cutting blade and move into a fixed cover covering an upper region of the cutting blade. The portable cutting device is provided with a dust box to collect the sparks and cutting dusts. The dust box is removably attached to the fixed cover. The rotating wind in the fixed cover is guided to the dust box, and the sparks and cutting dusts are collected in the dust box.

For example, a dust box is well known which can be attached to and detached from a fixed cover in a single operation by using a lock member that slides in a left-right direction with regard to an upper portion of the fixed cover. Apart from the lock member, the dust box has three positioning portions for positioning the dust box with regard to the fixed cover. Before the dust box is locked to the fixed cover by the lock member, the dust box is required to be positioned with regard to the fixed cover at the three positioning portions. Therefore, there is room for improvement in the positioning structure of the dust box. In addition, a dust collection chamber of the dust box is made of synthetic resin. Therefore, there is room for improvement in heat resistance.

For another example, a dust box is well known which can be attached to and detached from a side of the fixed cover by operating a knob screw. Therefore, there is room for improvement in the operability of attachment and detachment. A housing of the dust box is made of synthetic resin and has a half-split structure. Also, the dust box includes an aluminum die-cast component inside the housing. The aluminum die-cast component is placed closely on an inner wall of the half-split housing on a side far from the cutting blade. Because of this configuration, heat transferred from the sparks and cutting dusts to the aluminum die-cast component may be undesirably transferred to the half-split housing. In this respect, there is room for improvement in thermal countermeasures.

Conventional portable cutting devices such as, for example, metal cutters, masonry cutters, and portable circular saws have been provided. To cut a workpiece, a user grasps a handle of the portable cutting device and moves the portable cutting device against the workpiece while the cutting blade of the portable cutting device rotates. The cutting blade then cuts the workpiece. For example, a stand for a portable cutting device is well known which can be used as a stationary cutting device in which the portable cutting device is attached to the stand. The portable cutting device is attached to an attachment arm, and the portable cutting device together with the attachment arm are swung downward with respect to a base of the stand. This allows the cutting blade of the portable cutting device to cut into the workpiece placed on the base.

The portable cutting device has a movable cover that can cover a lower region of the cutting blade. The movable cover can be opened and closed between a closed position that covers the lower region of the cutting blade and an open position that exposes a lower region of the cutting blade. When the portable cutting device is independently used, the movable cover is pushed by the workpiece by movement of the portable cutting device in a cutting/progressing direction to rotate the movable cover in the open position. When the portable cutting device is mounted on the stand and used as a stationary cutting device, the movable cover has to be opened such that the cutting blade cuts into the workpiece.

For example, when the portable cutting device is mounted on the stand, the movable cover is maintained with the cutting blade exposed in such a manner that the cutting blade is opened more than necessary. In more detail, when the portable cutting device is swung downward with respect to the base of the stand, the movable cover opens from the predetermined open position to a position in which the lower region of the cutting blade is furthermore exposed. For another example, the movable cover is connected to a wire provided on the stand. The wire extends from a side opposite to the user to a user side through an upper portion of the portable cutting device, connecting to the movable cover. When the portable cutting device is at a top dead center with respect to the base of the stand, the movable cover is biased to the closed position. As the portable cutter swings downward, the movable cover rotates to be opened in an opening direction by the wire. This allows the cutting blade to be exposed from the position covered by the movable cover and to cut into the workpiece.

As described above, the conventional stands for portable cutting devices require somewhat time-consuming work to make the movable cover open. For example, in the case of the former example, it is necessary to attach and fix the portable cutting device to the attachment arm of the stand while opening the movable cover. In the case of the latter example, it is necessary to connect the portable cutting device to the movable cover while engaging a long wire with several portions of the portable cutting device.

Therefore, there is a need for a portable cutting device with a dust box to improve operability for detachably attaching the dust box to the cutting device main body. Furthermore, there is a need for a stand of the portable cutting device to improve operability for detachably attaching the portable cutting device to the stand.

### SUMMARY OF THE DISCLOSURES

According to one aspect of the present disclosure, a portable cutting device for cutting metal has a cutting device body and a dust box removably attachable to the cutting device body. A cutting blade is rotatably attachable to the cutting device main body. The dust box has a first housing, a second housing, and an inner plate. The first housing is made of synthetic resin with a first side that is positioned inside of the main body of the cutting device. The second housing is made of synthetic resin with a second side that is positioned opposite the first side and interconnected with the first housing. The inner plate is arranged through the second side surface and an air layer.

Because of this configuration, the sparks and cutting dusts generated by the cutting blade during a cutting work of the workpiece flow mainly to a side of the inner plate away from the cutting blade by the rotating wind. By arranging the air layer between the inner plate and the second side surface, a heat from the sparks and cutting dusts can be suppressed from being transmitted to the second housing. Accordingly, the user can easily hold the dust box, which improves workability of the attachment and detachment of the dust box to and from the cutting device main body.

### BRIEF DESCRIPTION OF DRAWINGS

FIG. 1 is a right side view of a portable cutting device according to an exemplary embodiment of the present disclosure.

FIG. 2 is a top view of the portable cutting device.

FIG. 3 is a cross-sectional view of the portable cutting device, taken along line III-III of FIG. 2.

FIG. 4 is an enlarged view of part IV in FIG. 3.

FIG. 5 is a cross-sectional view of the portable cutting device, taken along line V-V of FIG. 2.

FIG. 6 is an enlarged view of part VI in FIG. 5

FIG. 7 is a cross-sectional view of the portable cutting device, taken along line VII-VII of FIG. 1

FIG. 8 is an enlarged view of part VIII in FIG. 7.

FIG. 9 is a left side view of the portable cutting device without a motor housing, an electric motor, and handle housing.

FIG. 10 is an exploded perspective view of the portable cutting device in which a dust box is removed from the fixed cover in FIG. 9.

FIG. 11 is an exploded perspective view of the dust box, viewed from the rear left side.

FIG. 12 is an exploded perspective view of the dust box, viewed from the front right side.

FIG. 13 is a perspective view of a stationary cutting device in which a portable cutting device is mounted on a stand according to an exemplary embodiment, showing the portable cutting device is at a top dead center.

FIG. 14 is a right side view of the stationary cutting device at the top dead center

FIG. 15 is a view of the stationary cutting device at the top dead center, which is viewed from a user side.

FIG. 16 is a view of the stationary cutting device at the top dead center, which is viewed from a side opposite to the user.

FIG. 17 is a top view of the stand.

FIG. 18 is a base and the stand where a protrusion of an attachment arm is inserted into a circular hole of the base of the portable cutting device, which is viewed from above on a side opposite to the user in FIG. 14.

FIG. 19 is the base and the stand where the base is attached to the attachment arm, viewed in a direction indicated by arrow XIX in FIG. 14, which is the same direction as FIG. 18

FIG. 20 is a cross-sectional view of the base and the stand, taken along line XX-XX of FIG. 19.

FIG. 21 is a right side view of the stationary cutting device without the dust box at a top dead center before an end portion of a link arm engages an engaging portion of a movable cover.

FIG. 22 is a right side view of the stationary cutting device without the dust box at the top dead center immediately before the end portion of the link arm engages the engaging portion of the movable cover when the movable cover opens to some extent.

FIG. 23 is a right side view of the stationary cutting device without the dust box at the top dead center when the end portion of the link arm engages the engaging portion of the movable cover.

FIG. 24 is a right side view of the stationary cutting device when the portable cutting device moves downward from the top dead center for a cutting blade to cut into a workpiece

FIG. 25 is a right side view of the stationary cutting device when the portable cutting device is at a bottom dead center.

FIG. 26 is an enlarged view of the stationary cutting device viewed in a direction indicated by arrow XXVI in FIG. 13, when the portable cutting device is at the bottom dead center.

FIG. 27 is an enlarged view of the dust guide, viewed in a direction indicated by arrow XXVII in FIG. 13

FIG. 28 is a cross-sectional view of the portable cutting device and the dust guide, taken along line XXVIII-XXVIII of FIG. 15.

FIG. 29 is a right side view of a stationary cutting device in which the portable cutting device is mounted on a stand according to another embodiment, showing the portable cutting device is at the top dead center.

FIG. 30 is a right side view of the stationary cutting device without the dust box at the top dead center before an end portion of a link arm engages an engaging portion of a movable cover.

FIG. 31 is a right side view of the stationary cutting device without the dust box, when the portable cutting device at the top dead center is moved toward a side opposite to a user and immediately before an end portion of a link arm engages an engaging portion of the movable cover.

FIG. 32 is a right side view of the stationary cutting device without the dust box, when the portable cutting device at the top dead center is moved to the side opposite to the user and the end portion of the link arm engages the engaging portion of the movable cover.

FIG. 33 is a right side view of the stationary cutting device when the portable cutting device moves downward from the top dead center for the cutting blade to cut into the workpiece.

FIG. 34 is a right side view of the stationary portable cutting device when the portable cutting device is at the bottom dead center.

FIG. 35 is a right side view of a stationary cutting device in which the portable cutting device is mounted on a stand according to further another embodiment, showing that the portable cutting device is at the top dead center.

FIG. 36 is a right side view of the stationary cutting device without the dust box at the top dead center immediately before the end portion of the link arm engages the engaging portion of the movable cover when the movable cover is opened.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

According to another aspect of the present disclosure, an upper opening is formed in a dust housing chamber of the dust box between the first side surface of the first housing and the inner plate. Accordingly, the sparks and cutting dusts can be more reliably guided into the dust collection chamber. By arranging the air layer between the inner plate and the second side surface, the dust collection chamber is thermally protected, preventing the second side surface from becoming too hot for the user to hold. Because of this configuration, the hot cutting dusts can be housed in the dust collection chamber while a good usability of the dust box.

According to another aspect of the present disclosure, the inner plate is made of aluminum. Therefore, the temperature of the inner plate becomes uniform. Moreover, the rotating wind of the cutting blade blows against an entirety of the inner plate. Because of this configuration, the cooling efficiency of the inner plate can be improved.

According to another aspect of the present disclosure, the inner plate is uniform in thickness. Therefore, localized rise in temperature can be prevented. Accordingly, the temperature of the inner plate becomes uniform.

According to another aspect of the present disclosure, the inner plate measures about 0.3 mm to 1.0 mm in thickness. Therefore, the inner plate is lightweight, and accordingly the dust box can be made lightweight. Furthermore, an air layer having a thickness larger than a predetermined length can be easily arranged between the inner plate and the second side surface.

According to another aspect of the present disclosure, the inner plate is made of aluminum with a surface emissivity of 0.2 or less. Because of the low emissivity of the inner plate, less heat is radiated from the inner plate as electromagnetic waves even when the temperature of the inner plate rises. Accordingly, the first housing and the second housing can be suppressed from being heated by heat radiation from the inner plate.

According to another aspect of the present disclosure, a spacer that is formed integrally with or separate from the second housing is arranged between the inner plate and the second side surface of the second housing. Because of the presence of the rib, the air layer having a thickness larger than a predetermined length can be arranged.

According to another aspect of the present disclosure, the spacer can be formed integrally with the second housing as a rib or can be a separate component. Accordingly, the air layer can be formed without increasing the number of parts. Due to the small number of parts, assemblability of the dust box can be improved.

According to another aspect of the present disclosure, the inner plate is pressed against the first housing by the spacer. Accordingly, the inner plate can be firmly held simply by holding the inner plate between the ribs of the second housing and the first housing. Therefore, the dust box can be assembled with a simple structure, suppressing heat accumulation inside of the dust box.

According to another aspect of the present disclosure, the first housing, the second housing, and the inner plate are integrally assembled by screwing the second housing to the first housing. Accordingly, assemblability of the dust box can be efficiently improved.

According to another aspect of the present disclosure, a lower portion of the first housing and a lower portion of the second housing cooperate to form a bottom of the dust collection chamber of the dust box. Accordingly, the bottom portion of the dust collection chamber can be formed to prevent the cutting dusts from scattering while improving assemblability of the dust box.

According to another aspect of the present disclosure, the air layer is 0.5 mm or more in thickness. Therefore, the second side surface can be suppressed from rising in temperature. Accordingly, the temperature of the outer surface of the dust box can be suppressed to such a degree that, for example, the user can hold the dust box.

According to another aspect of the present disclosure, a through hole that penetrates the second housing toward the air layer is formed in the second housing. Accordingly, an outside air flows into and out of the air layer through the through-holes. Therefore, the inner plate can be suitably cooled.

According to another aspect of the present disclosure, a front port is situated at a front portion of the dust box for collections of cutting dusts. The through hole is arranged in a rear area of the dust box behind a rotation center of the cutting blade. Accordingly, the sparks and cutting dusts are carried by the rotating wind of the cutting blade from the front port to the rear area of the dust box behind the rotation center of the cutting blade. The through-holes are arranged, through the air layer, opposite to the inner plate of the rear area of the dust box to which the sparks and cutting dusts are carried. Accordingly, the inner plate, which is warmed by the heat of the sparks and cutting dusts, can be efficiently cooled by the outside air flowing via the through-holes.

According to another aspect of the present disclosure, the dust box has a front port to which the cutting dusts are carried. The dust box has a front engaging portion removably engageable with the cutting device main body in a left-right direction, and a rear engaging portion removably engageable with the cutting device main body in the left-right direction. The dust box also has an operation portion arranged either in the front engaging portion or the rear engaging portion. The operation portion is configured to be disengagable from the cutting device main body by pushing the operation portion.

Because of this configuration, the dust box can be firmly fixed to the cutting device main body at the two points, i.e., at the front engaging portion and the rear engaging portion. Accordingly, the number of engaging portions can be reduced, which can prevent the dust box from being enlarged. In addition, both the front engaging portion and the rear engaging portion are arranged to engage with each other in the left-right direction, and also either one is arranged as the operation portion that can be pushed for operation. This prevents the dust box having the front engaging portion and the rear engaging portion from being enlarged in the front-rear direction and in the up-down direction. Accordingly, the operativity of the dust box for attaching and detaching the dust box to and from the cutting device main body can be improved.

According to another aspect of the present disclosure, either the front engaging portion or the rear engaging portion is arranged on the first side surface of the dust box. Accordingly, the front engaging portion or the rear engaging portion can be arranged by the use of a dead space on an inner side of the cutting device main body, i.e., between the cutting device main body and the dust box. Because of this configuration, the dust box can be prevented from being enlarged.

According to another aspect of the present disclosure, both the front engaging portion and the rear engaging portion are arranged on the first side surface of the dust box. Accordingly, the dust box can be prevented from being enlarged by arranging both the front engaging portion and the rear engaging portion in the dead space on the inner side of the cutting device main body, i.e., between the cutting device main body and the dust box.

According to another aspect of the present disclosure, the rear engaging portion is the operation portion. Therefore, the rear area of the dust box is heavier than the front area because the cutting dusts are accumulated in the rear area. The arrangement of the operation portion in the rear area of the dust box allows the dust box to be removed from the cutting device main body for carriage of the dust box in a well-balanced manner in that condition.

According to another aspect of the present disclosure, the operation portion has a pushable portion on an upper side of the operation portion and an engaging portion engageable with the cutting dust main body on a lower side of the operation portion. The pushable portion is integrally formed with the engaging portion. By arranging the pushable portion on the upper side where heat from the cutting dusts is not easily transferred, operability of the operation portion can be improved. In addition, the operation portion can be operated by pushing the pushable portion while holding the dust box from above. Accordingly, workability of attaching to and detaching from the dust box can be improved.

According to another aspect of the present disclosure, either one of the front engaging portion or an engaged portion of the cutting device main body engageable with the front engaging portion is convex and the other a concave. Accordingly, the front engaging portion and the front engaged portion can be arranged in a simple structure for easy positioning.

According to another aspect of the present disclosure, a distance between the front engaging portion and the rear engaging portions in a front-rear direction is larger than a half of a diameter of the cutting blade. Because of the large distance between the front engaging portion and rear engaging portion, the dust box can be reliably positioned and firmly held to the cutting dust main body with a small number of engaging portions.

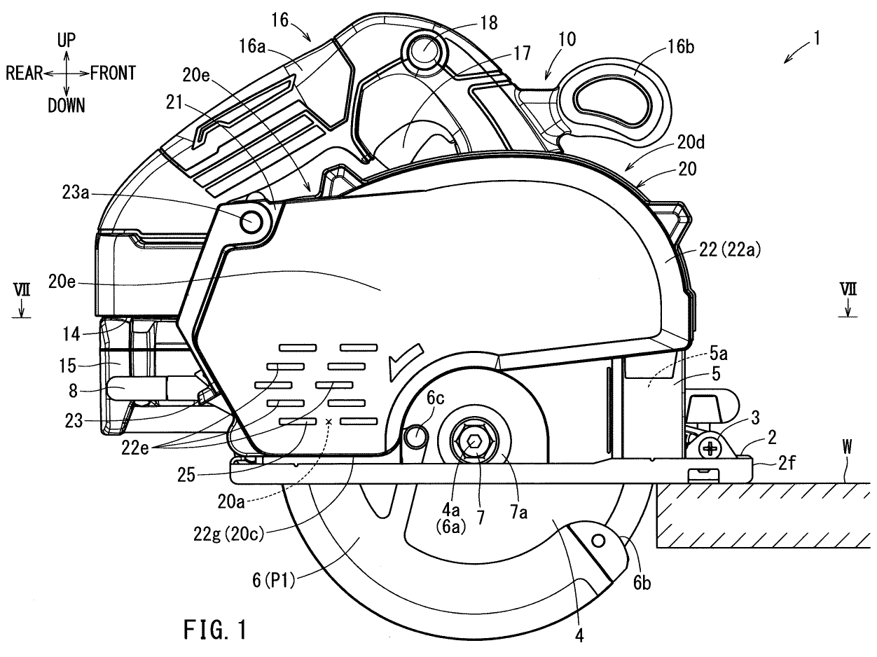

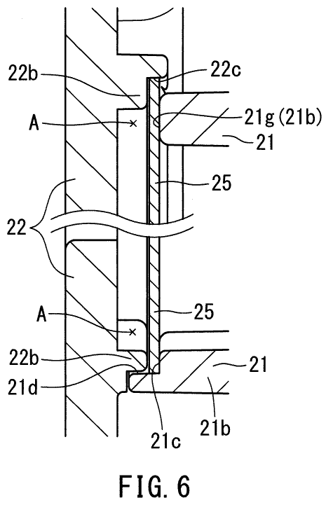

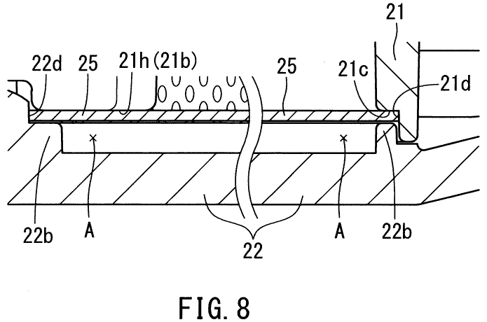

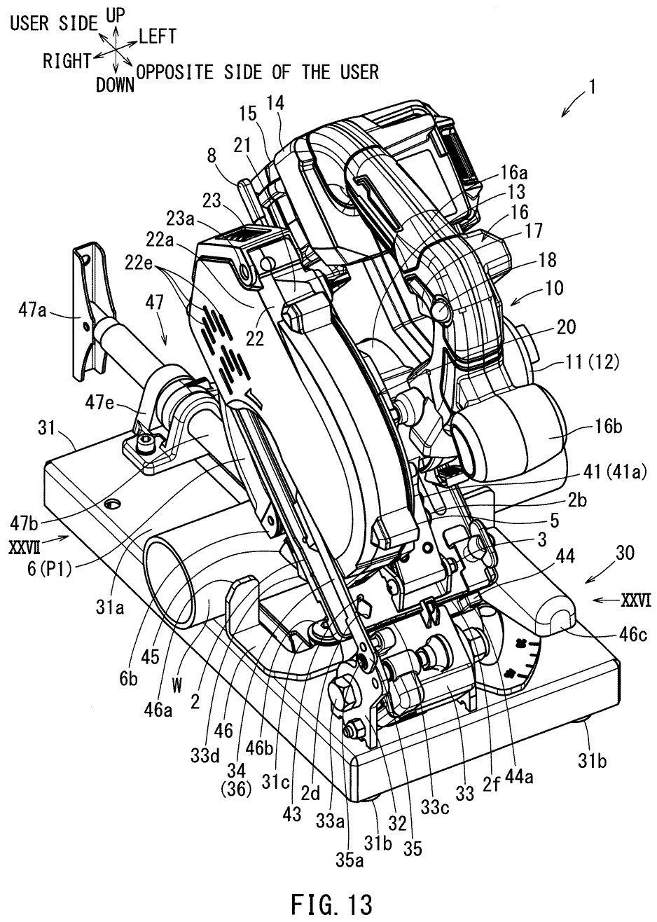

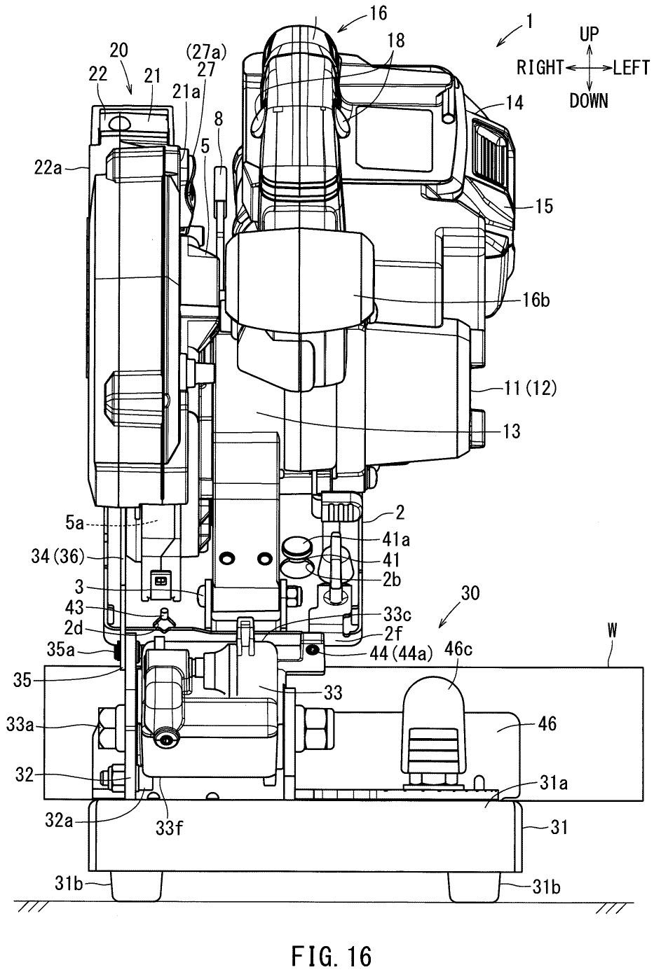

An example of the present disclosure is described with reference to FIG. 1 to FIG. 28. The example shows a portable cutting device 1 for cutting metal, which is referred to as a metal cutter. Also, the example shows a stand 30 for the portable cutting device 1, which can be used as a stationary cutting device for cutting metal by attaching the stand 30 to the portable cutting device 1. Among stationary cutting devices for cutting metal, those that use a cutting wheel as a cutting tool are called “abrasive chop saws”. Also, those that use a tipped saw blade as a cutting tool are called “metal cutting chop saws”. As shown in, for example, FIG. 13, the portable cutting device 1 is supported above the stand 30 so as to be swingable in an up-down direction. The cutting device main body 10 of the portable cutting device 1 has a disk-shaped tipped saw blade as a cutting blade 4. In the following explanation of the portable cutting device 1 when used alone, a cutting/progressing direction is a forward direction and a direction opposite to the cutting/progressing direction is a backward direction. Also, in the explanation of a stationary cutting device where the portable cutting device 1 for cutting metal is attached to the stand 30, a front side where a user is located is a user side, and a rear side of the user is a side opposite to the user side (opposite side of the user). An up-down direction and a left-right direction are defined based on the user's position situated behind the portable cutting device 1 or on the user side of the stationary cutting device for cutting metal.

As shown in FIGS. 1 to 3, the portable cutting device 1 has an approximately rectangular plate-shaped base 2 that is placed on a workpiece when used alone. The base 2 is provided with a window 2a that penetrates in the up-down direction, which is a direction of the board thickness. The window 2a extends approximately in a front-rear direction. The cutting blade 4 can protrude downward from a lower surface of the base 2 through the window 2a. The cutting blade 4 cuts into the workpiece W by the region of the cutting blade 4 protruding downward from the base 2.

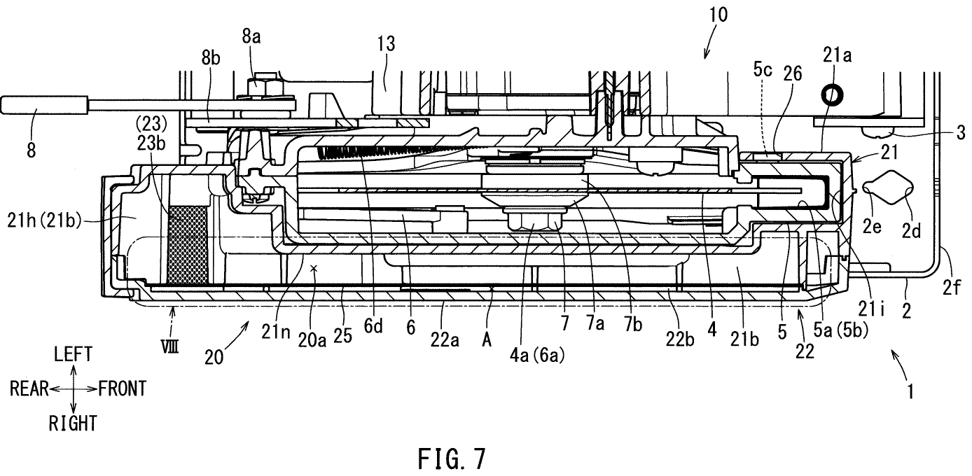

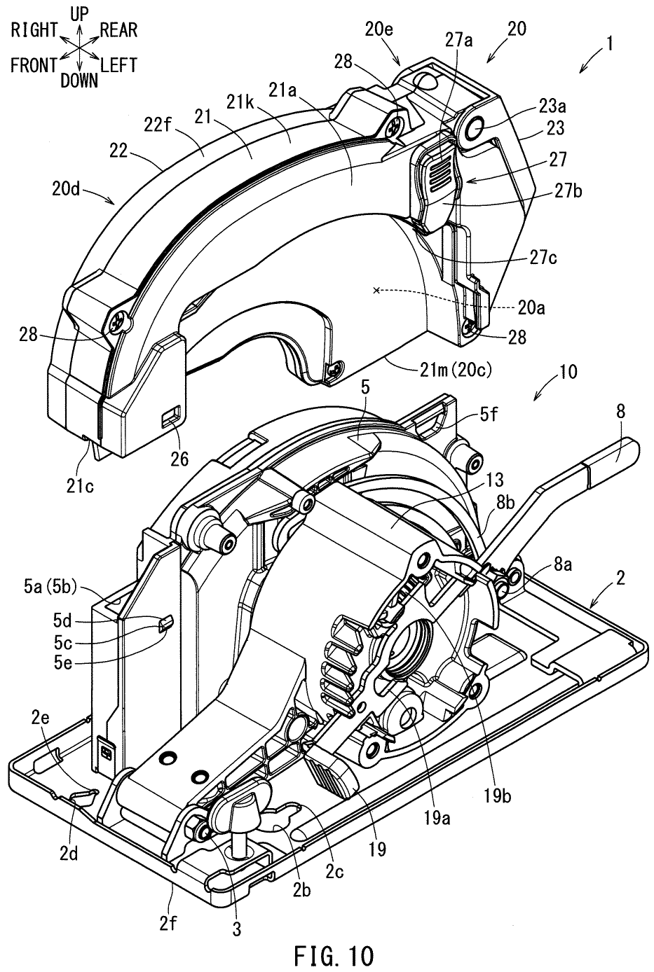

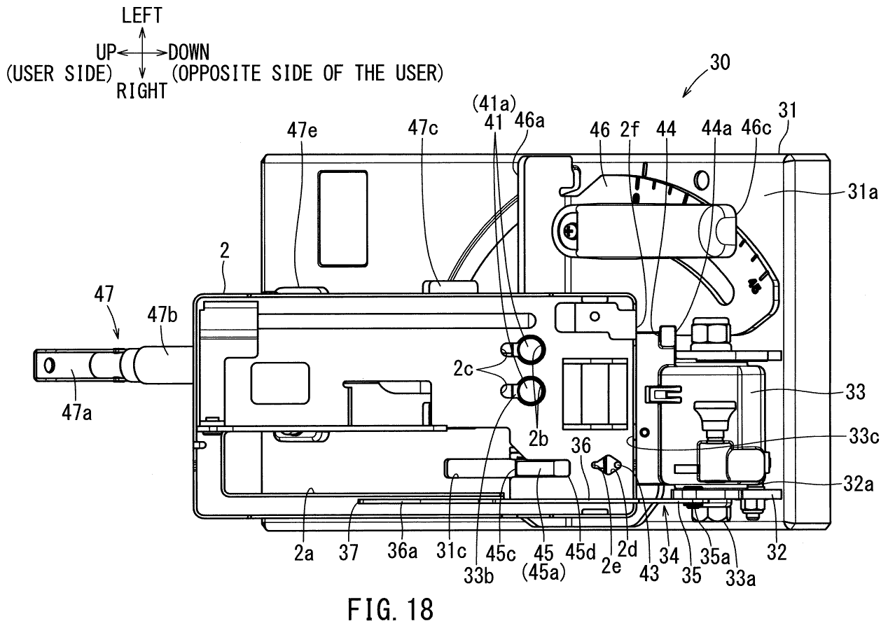

As shown in FIGS. 10 and 18, two circular holes 2b penetrating in the up-down direction are provided in the front left part of the base 2. The two circular holes 2b are spaced apart in the left-right direction and are aligned at the same position in the front-rear direction. A narrow width hole 2c, which is connected to a rear portion of each circular hole 2b, is formed penetrating through the base 2 in the up-down direction and extending in the front-rear direction. The width of the narrow width hole 2c in the left-right direction is smaller than the diameter of the circular hole 2b. An approximately diamond-shaped hole 2d penetrating through the base 2 in the up-down direction is formed in the front right part of the base 2. The hole 2d is longer in the front-rear direction than in the left-right direction. The center of the hole 2d in the left-right direction is positioned on an extension line of the center of the cutting blade 4 in the left-right direction (refer to FIG. 7). By aligning the center of the hole 2d in the left-right direction with a marking line of the workpiece W, the cutting blade 4 can cut into the workpiece W in line with the marking line. A narrow width portion 2e, which is connected to a rear end of the hole 2d, penetrates the base 2 in the up-down direction and extends in the front-rear direction.

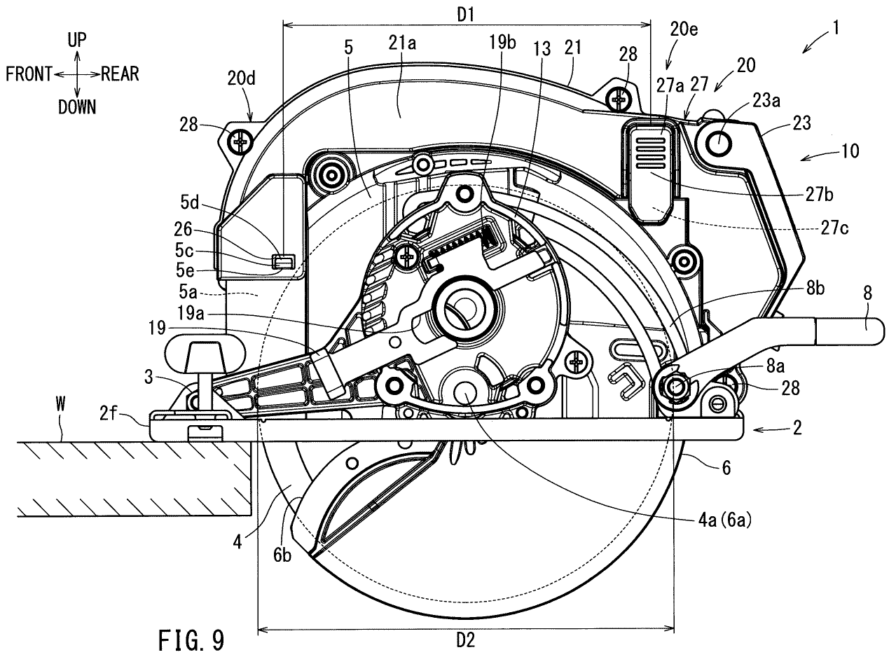

As shown in FIGS. 1, 2, and 9, a vertical swing shaft 3 is arranged on the front upper side of the base 2. The cutting device main body 10 of the cutting device 1 can be swung in the up-down direction with respect to the base 2 around the vertical pivot axis 3. A depth guide 8b extending upward is arranged on a rear side of the base 2. The depth guide 8b includes an arc-shaped hole penetrating in the left-right direction. The depth guide 8b is connected to a fixed cover 5 by a bolt 8a. The fixed cover 5 is discussed later in detail. A fixing lever 8 is connected to the depth guide 8b through the bolt 8a such that the fixing lever 8 is swingable in the up-down direction. When the fixing lever 8 is rotated in the tightening direction, a swing position of the cutting device main body 10 in the up-down direction can be locked with respect to the depth guide 8b. Because of this configuration, a length of the cutting blade 4 protruding from the lower surface of the base 2 is locked. Accordingly, a cutting depth of the cutting blade 4 is locked. On the contrary, when the fixing lever 8 is rotated in a loosening direction, the cutting device main body 10 of the cutting device 1 can be swung in the up-down direction with respect to the depth guide 8b. This allows the cutting depth of the cutting blade 4 to be changed. The figures, for example FIGS. 1 and 9, show that the cutting device main body 10 is locked at the bottom dead center with respect to the base 2.

As shown in FIGS. 1, 5, 7, and 10, the cutting device main body 10 of the portable cutting device 1 has a fixed cover 5 covering a region above the cutting blade 4. A dust box 20 can be removably attached to the fixed cover 5. The dust box 20 serves as an entry point for collecting sparks and cutting dusts generated by the cutting blade 4 while cutting the workpiece W. Also, the dust box 20 collects cutting dusts generated when the sparks cool. The dust box 20 will be discussed later in detail. A dust passage 5a extending in the up-down direction is formed at a front portion of the fixed cover 5. A bottom end of the dust passage 5a is positioned directly above the window 2a of the base 2 when the cutting device main body 10 is at the bottom dead center. The cutting blade 4 rotates in a counterclockwise direction in FIG. 1. The sparks and cutting dusts, which are generated when the cutting blade 4 cuts into the workpiece W, flow to the dust passage 5a in an upward direction along the rotating cutting blade 4. An upper opening 5b in the form of a rectangular shaped through hole is formed at an upper end of the dust passage 5a.

As shown in FIGS. 1, 7, and 9, the fixed cover 5 is assembled with a movable cover 6 that is rotatable to open and close a lower region of the cutting blade 4. The movable cover 6 is closed by rotating in a counterclockwise direction in FIG. 1 to cover the lower region of the cutting blade 4. The movable cover 6 is opened by rotating in a clockwise direction in FIG. 1 to expose a lower region of the cutting blade 4, depending on the opening amount of the movable cover 6. A rotation center 6a of the movable cover 6 is coaxial with a rotation center 4a of the cutting blade 4. The movable cover 6 is biased in its closing direction by a tension spring 6d. The movable cover 6 is normally maintained at a closed position. The movable cover 6 includes an end portion 6b at the end of the movable cover 6 in the closed direction. The end portion 6b of the movable cover 6 contacts the workpiece W. By moving the portable cutting device 1 toward the workpiece W in a forward direction (cutting direction), the end portion 6b is pressed against the workpiece W. This causes the movable cover 6 to be pressed against a side of the workpiece W. Because of this configuration, the movable cover 6 rotates in the opening direction against a biasing force of the tension spring 6d.

As shown in FIG. 1, the movable cover 6 is provided with a cylindrical engaging portion 6c protruding in a rightward direction. The engaging portion 6c is positioned in an adjoining area of the rotation center 6a such that the engaging portion 6c does not interfere with the fixed cover 5 and dust box 20 when the movable cover 6 rotates. The engaging portion 6c is releasably engaged with a link arm 34 of the stand 30. The link arm 34 of the stand 30 will be discussed later in detail.

As shown in FIGS. 1 and 7, the cutting blade 4 is attached to an output shaft (not shown) by a fixing screw 7. A center of the fixing screw 7 is coaxial with the rotation center 4a of the cutting blade 4. The cutting blade 4 is fixed to the output shaft by being held with an outer flange 7a and an inner flange 7b from both sides of the cutting blade 4.

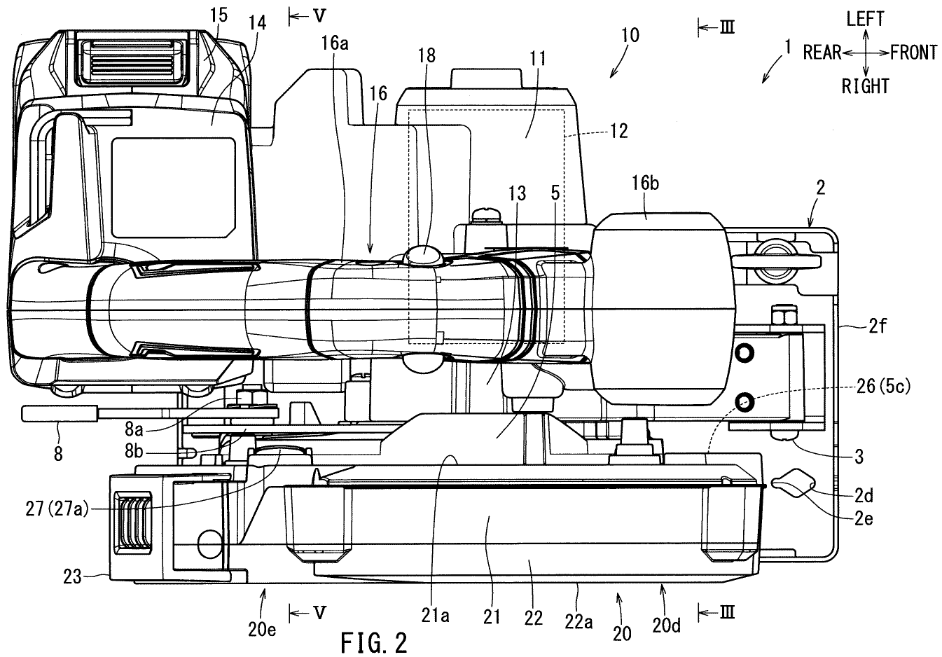

As shown in FIG. 2, a gear housing 13 is provided on a left side of the fixed cover 5. The gear housing 13 houses a reduction gear train. A front portion of the gear housing 13 is connected to a vertical swing shaft 3 so as to be swingable in the up-down direction. A tubular-shaped motor housing 11 that houses an electric motor 12, e.g., a DC brushless motor is provided on a left of the gear housing 13. A rotation power of the electric motor 12 is reduced via the reduction gear train in the gear housing 13 and transmitted to the output shaft, which causes the cutting blade 4 to rotate. A battery attachment portion 14 is provided behind the motor housing 11. A rechargeable battery 15 serving as a power source of the portable cutting device 1 can be removably attached to the battery attachment portion 14. The battery 15 can be attached to the battery attachment portion 14 by sliding the battery 15 from left to right. The battery 15 can be removed from the battery attachment portion 14 by sliding the battery 15 from right to left.

As shown in FIGS. 1 and 2, a handle housing 16 is provided at an upper portion of the cutting device main body 10. The handle housing 16 is above the motor housing 11, gear housing 13, and battery attachment portion 14, straddling in the front-rear direction. The handle housing 16 includes a loop-shaped main handle 16a extending in the front-rear direction. A user can hold the main handle 16a to carry the portable cutting device 1. When using the portable cutting device 1, the user can move the portable cutting device 1 in a cutting/progressing direction to perform a cutting work. When the portable cutting device 1 is mounted on the stand 30 to use for a stationary cutting device, the user holds the main handle 16a and moves the portable cutting device 1 in an up-down direction with respect to the stand 30 to perform the cutting work.

As shown in FIG. 1, a trigger 17 is provided on an upper inner circumferential side of the loop-shaped main handle 16a. When the trigger 17 is pulled with a fingertip of the user's hand holding the main handle 16a, the electric motor 12 (refer to FIG. 2) is activated to rotate the cutting blade 4. A lock-off button 18 is provided above the trigger 17. The lock-off button 18 can be pushed in the left-right direction. By pushing the lock-off button 18, the trigger 17 becomes unlocked to allow the trigger 17 to be able to pull. This prevents an unintentional pull operation of the trigger 17. A circular ring-shaped sub handle 16b is provided on a front side of the handle housing 16.

As shown in FIGS. 9 and 10, the cutting device main body 10 has a shaft lock 19. The shaft lock 19 is provided in the gear housing 13 so as to be slidable in a direction perpendicular to the output shaft. An operation portion of the shaft lock 19 is exposed from the gear housing 13 at a front lower portion of the gear housing 13. The shaft lock 19 has a flat part 19a in the width direction inside of the gear housing 13. The flat part 19a has two flat surfaces which face each other and extend in parallel with each other. The shaft lock 19 is biased tilted downward to the front by a compression spring 19b along a sliding direction toward the front side. When the shaft lock 19 is pushed upward toward the rear side against the biasing force, the flat part 19a moves toward the rotary shaft of one of the gears in the reduction gear train. The rotation shaft of the gear has a flat part in the width direction that can be engaged with the flat part 19a of the shaft lock 19. Because of this configuration, by pushing the shaft lock 19 against the biasing force, each gear of the reduction gear train and the output shaft can be prevented from rotating. At this time, the fixing screw 7 (refer to FIG. 1) can be removed from the output shaft in order to replace the cutting blade 4.

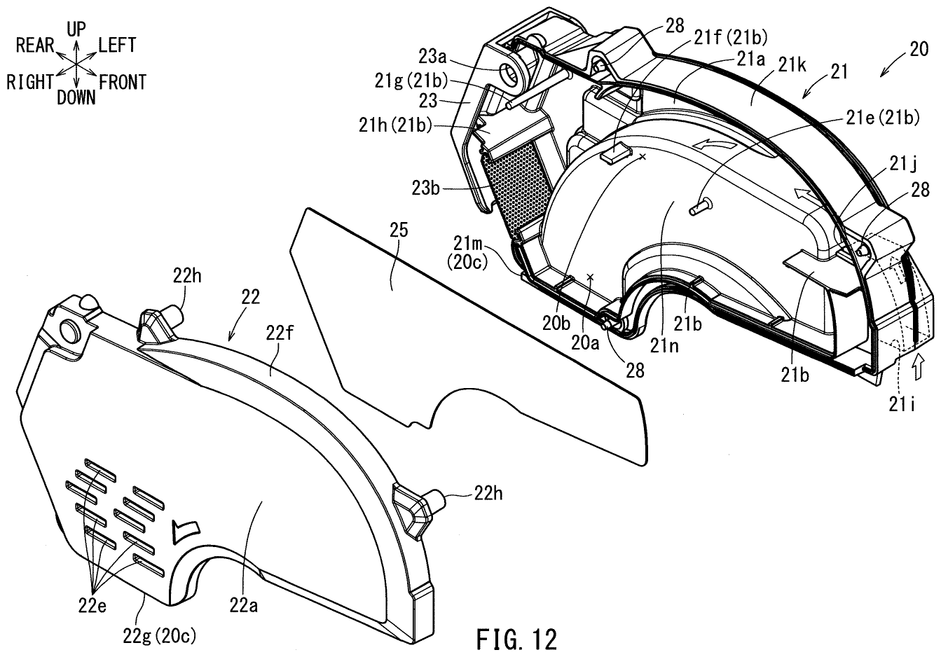

As shown in FIGS. 1, 9, and 10, the dust box 20 is removably attached to the fixed cover 5 to cover the fixed cover 5 from above. An upper surface, a left surface, and a right surface of the dust box 20 cover an upper surface, a left surface, and a right surface the fixed cover 5 from the outside, respectively. A front end of the dust box 20 is at approximately the same position as the front end of the fixed cover 5. A rear end of the dust box 20 is located behind the rear end of fixed cover 5. Referring to FIG. 12, the dust box 20 has a connection port 21i that opens downward at a front portion of the dust box 20. Further, a front port 21j that is connected to the interior of the dust box 20 is formed above the connection port 21i. By connecting the connection port 21i to the upper opening 5b of the fixed cover 5, a dust collection path for the sparks and cutting dusts generated by the cutting blade 4 is formed which leads from a cutting position of the workpiece W to the dust box 20 through the dust passage 5a. As shown in FIG. 12, the sparks and cutting dusts move upward from the connection port 21i to the front port 21j as shown by a void arrow in FIG. 12. Furthermore, the sparks and cutting dusts move rearward from the front port 21j along an upper portion of the dust box 20. A lower rear portion of the dust box 20 is a dust collection chamber 20a where the cutting dusts accumulate.

As shown in FIGS. 10 to 12, the dust box 20 has a half-split structure in which a first housing 21 on a left side is assembled with a second housing 22 on a right side to form the dust box 20. The first housing 21 is placed closer to the gear housing 13 than the second housing 22. The first housing 21 and the second housing 22 are made of synthetic resin. For example, the first housing 21 can be made of polyamide resin with glass fiber material having high heat resistance. The second housing 22 can be made of transparent polycarbonate resin without glass fiber material for better visibility. Instead, both the first and second housings can be made of polyamide resin with glass fiber material for greater heat resistance. Further, both the first and second housings may be made of transparent polycarbonate resin without glass fiber material for greater visibility.

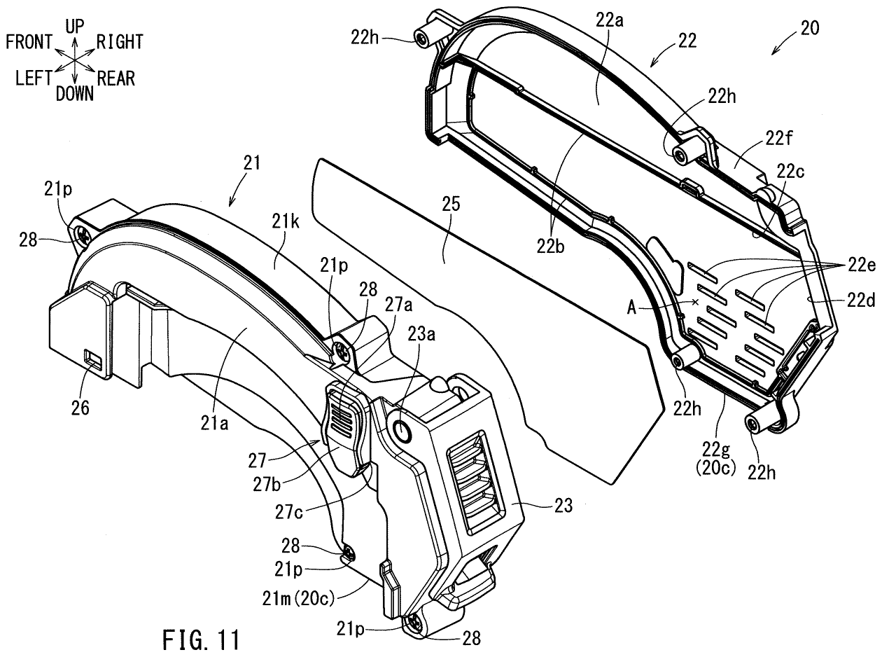

As shown in FIGS. 11 and 12, the first housing 21 and the second housing 22 are connected by a plurality of screws 28. The plurality of screws 28 are screwed in four locations, for example, at the front, rear, top, and bottom of the dust box 20. The first housing 21 is provided with through holes 21p passing through in the left-right direction at the four locations where the screws 28 are to be mounted. The second housing 22 is provided with screw holes 22h extending in the left-right direction at the four locations where the screws 28 are to be mounted. The screws 28 are inserted and fastened from the left side of the first housing 21 to the right side of the second housing 22. The through holes 21p and the screw holes 22h in the front, rear and top of the dust box 20 are provided in protruding bosses that protrude outward from the first housing 21 and second housing 22, respectively. Because of this configuration, an airflow in the dust collection path inside of the dust box 20 can be less likely to be blocked.

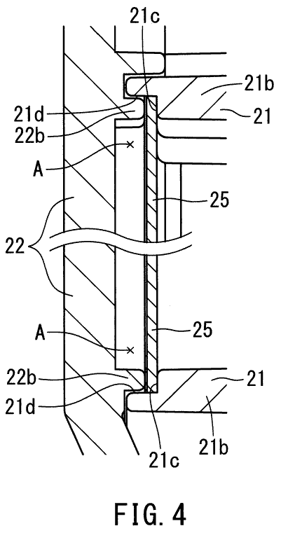

As shown in FIGS. 10 to 12, the first housing 21 has a first side surface 21a on a left end side of the first housing 21. The first side surface 21a is erected in the up-down direction and extends approximately in the front-to-rear direction. The connection port 21i and the front port 21j are located on the front side of the first housing 21. A passage, which is shown in void arrows in FIG. 12, that connects the front port 21j and extends above the fixed cover 5 in the front-rear direction is formed below an upper portion 21k of the first housing 21. A plurality of ribs 21b extending rightward are formed on a right side of the first housing 21. The plurality of ribs 21b have a length for closely contacting an inner plate 25. In more detail, as shown in FIGS. 4, 6, 8, a distal end of a horizontal direction positioning portion 21c of each rib 21b in a radial direction of the cutting blade 4 contacts the inner plate 25 on a right side of the rib 21b. An outer portion of each rib 21b in the radial direction of the cutting blade 4 further extends in the rightward direction to form a step. A surface direction positioning portion 21d of the step of the rib 21b contacts the inner plate 25. In other words, the surface direction positioning portion 21d of each rib 21b restricts a movement of the inner plate 25 in the radial direction of the cutting blade 4. Referring to FIGS. 2, 9, and 10, a lower portion 21m of the first housing 21 is positioned on a right side of the rear portion of the fixed cover 5. Other horizontal direction positioning portions are provided in addition to 21c, 21e in the adjoining area of a middle in the front-rear direction, 21f at a rear portion, 21g at an upper rear portion, and 21h at a lower rear portion of the first housing 21, each protruding in the rightward direction.

As shown in FIGS. 1, 11, and 12, the second housing 22 has a second side surface 22a on a right end side of the second housing 22. The second side surface 22a is erected in the up-down direction and extends approximately in the front-rear direction. An upper portion 22f of the second housing 22 cooperates with an upper portion 21k of the first housing 21 to form a dust collection path extending in the front-rear direction. The second housing 22 has a plurality of ribs (spacers) 22b extending from the second side surface 22a in the leftward direction. The plurality of ribs 22b are formed integrally with the second side surface 22a using the same material. The plurality of ribs 22b have a length for closely contacting the inner plate 25. As shown in FIGS. 4, 6, and 8, the plurality of ribs 22b face the horizontal direction positioning portion 21c of the plurality of ribs 21b of the first housing 21 in the left-right direction. The plurality of ribs 22b and the plurality of the horizontal direction positioning portion 21c cooperate to push and hold the inner plate 25 in the left-right direction. In other words, the plurality of ribs 22b and the plurality of horizontal direction positioning portions 21c restrict the movement of the inner plate 25 in the direction perpendicular to the surface direction of the inner plate 25 (a direction perpendicular to the surface of the cutting blade 4). Surface direction positioning portions 22c and 22d are formed at the upper and rear portions of the rib 22 in the same manner as the rib 21b. The movement of the inner plate 25 in the surface direction is restricted by cooperating with the surface direction positioning portion 21d of the first housing 21 and the surface direction positioning portions 22c, 22d of the second housing 22.

As shown in FIGS. 1, 5, 11, and 12, a plurality of through-holes 22e penetrating the second housing 22 in the left-right direction are formed at a rear portion of the second side surface 22a. The plurality of-through holes 22e are located in a rear area 20e behind the rotation center 4a of the cutting blade 4. The through-hole 22e is typically rectangular and extends in the front-rear direction. Outside air flows into an air layer A via the through-holes 22e. Also, inside air flows outward from the air layer A via the through-holes 22e. A lower portion 22g of the second housing 22 is located below the plurality of through-holes 22e. The lower portion 22g is connected to the lower portion 21m of the first housing 21 in a left-right direction. The lower portion 22g and the lower portion 21m cooperate to form a bottom portion 20c of the dust collection chamber 20a. The dust collection chamber 20a can house the cutting dusts generated during a cutting operation of the workpiece W.

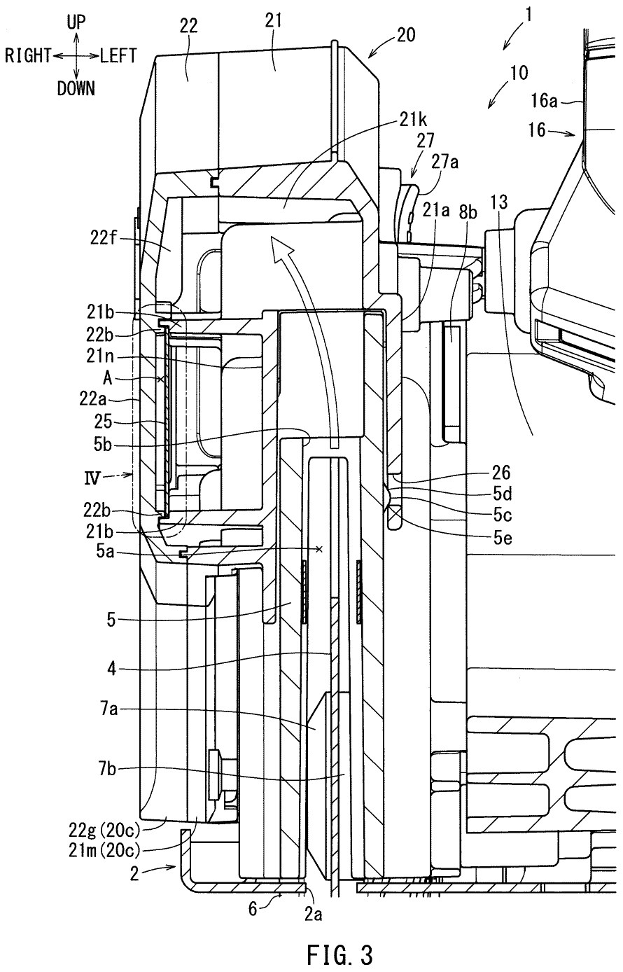

As shown in FIGS. 3 to 8, 11, and 12, a flat inner plate 25 is arranged between the first housing 21 and the second housing 22 in the left-right direction. The inner plate 25 is formed having a shape and a size such that the inner plate 25 covers the lower area of the second side surface 22a to face the plurality of through-holes 22e. Accordingly, the inner plate 25 overlaps all through-holes 22e in the front-rear direction and in the up-down direction. The inner plate 25 has a uniform thickness in the left-right direction. For example, the thickness of the inner plate 25 is 0.3 mm at minimum and 1.0 mm at maximum.

The inner plate 25 shown in FIGS. 1, 2, 8, 11, and 12 is made of a material with a low emissivity. That is, the surface of the inner plate 25 has a low surface emissivity. For example, the emissivity of the surface of the inner plate 25 is 0.3 or less, and more preferably 0.2 or less. The low emissivity of the surface of the inner plate 25 reduces a heat radiated from the surface of the inner plate as an electromagnetic wave when the inner plate 25 is heated. The inner plate 25 is made of metal, such as aluminum, iron, magnesium, etc., and more preferably aluminum. The inner plate 25 made of aluminum is preferable because the higher the purity, the lower the emissivity. Furthermore, it is preferable to polish the surface of the inner plate 25. This is because a polished surface has a lower emissivity than a rough surface. Also, a non-oxidized surface is preferable to an oxidized one because the former has a lower emissivity than the latter. Also, it is preferable not to apply surface treatment and coating to the inner plate 25 such as alumite treatment for avoiding a high emissivity.

As shown in FIGS. 1, 3 to 8, 11, and 12, the inner plate 25 extends in the front-rear direction parallel to the second side surface 22a. The front end of the inner plate 25 contacts the surface direction positioning portion 21d of the rib 21b at the front end of the first housing 21. The rear end of the inner plate 25 contacts the surface direction positioning portion 22d of the rib 22b at the rear end of the second housing 22. The upper end portion and the lower end portion of the inner plate 25 closely contact the ribs 22b extending in the front-rear direction, respectively. Because of this configuration, the air layer A is formed between the inner plate 25 and the second side surface 22a, which is surrounded by the inner wall of the second housing 22 and the ribs 22b. The air layer A separates from a left-side area of the inner plate 25. Accordingly, the sparks and cutting dusts can be prevented from entering the air layer A. The cutting dusts accumulate in the dust collection chamber 20a on the left side of the inner plate 25. The air layer A has a uniform thickness in the left-right direction corresponding to the protruding length of the ribs 22b. A lower limit of the thickness of the air layer A is, for example, 0.5 mm, or alternatively, 1.5 mm. An upper limit of the thickness of air layer A is, for example, 4.5 mm, or alternatively, 2.5 mm. The air layer A suppresses an amount of heat transferred from the inner plate 25 to the second side surface 22a of the second housing 22, which is heated by a remaining heat of the accumulated cutting dusts in the dust collection chamber 20a.

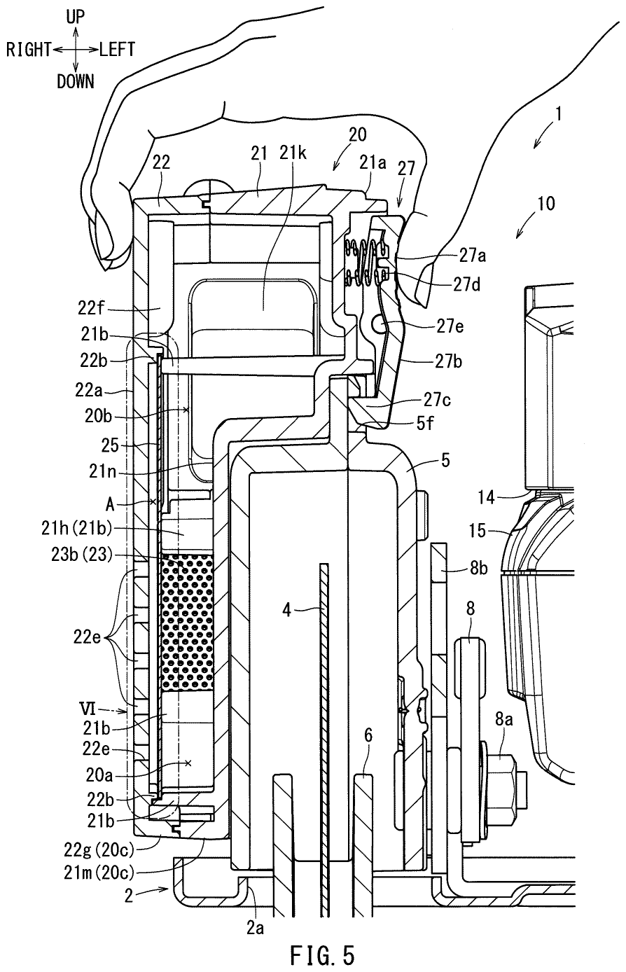

As shown in FIGS. 5 and 12, the dust collection chamber 20a is connected to an upper interior of the dust box 20 via an upper opening 20b that faces upward. The upper opening 20b is formed between an erection wall 21n of the first housing 21 and the inner plate 25 in the left-right direction. The erection wall 21n extends in the surface direction of the cutting blade 4 on the right side of the cutting blade 4. In other words, the erection wall 21n extends on the left side of the inner plate 25 approximately parallel to the inner plate 25 in the up-down direction and in the front-rear direction. Also, the erection wall 21n also extends on the right side of the first side surface 21a approximately parallel to the first side surface 21a in the up-down direction and in the front-read direction. The sparks and cutting dusts, which are carried from the front port 21j in the rearward direction, are carried further from the upper opening 20b downward to the dust collection chamber 20a. Because of the presence of the inner plate 25, the sparks and cutting dusts are prevented from entering the air layer A.

As shown in FIGS. 1, 7, 11, and 12, a discharge door 23 is arranged at the rear end of the dust box 20. The accumulated cutting dusts are cooled in the dust box 20 and discharged from the discharge door 23. The rear end of the dust box 20 can be opened and closed by rotating the discharge door 23 in the up-down direction around a rotation shaft 23a of the discharge door 23. The rotation shaft 23a is disposed at an upper end of the discharge door 23. A discharge section 23b is formed at a lower portion of the discharge door 23. The discharge section 23b is located behind the dust collection chamber 20a, and behind the inner plate 25 and the through holes 22e. The discharge section 23b includes a metal plate, so called a punch metal, having a plurality of minute through holes. An air flow caused by rotation of the cutting blade 4, which brings the sparks and cutting dusts to the dust collection chamber 20a, is discharged outside from the dust box 20.

As shown in FIGS. 2, 3, 5, 7, 9, and 10, the first side surface 21a of the second housing 22 of the dust box 20 has a structure in which the dust box 20 can be attached to and detached from the fixed cover 5. A front engaging portion (recess) 26 is formed in a front area 20d of the dust box 20 in front of the rotation center 4a of the cutting blade 4. A rear engaging portion (operation portion) 27 is formed in a rear area 20e of the dust box 20 behind the rotation center 4a of the cutting blade 4. As shown in FIG. 9, a distance D1 between the front engaging portion 26 and the rear engaging portion 27 in the front-rear direction is larger than a half of a diameter D2 of the cutting blade 4.

As shown in FIGS. 2, 3, 9, and 10, the front engaging portion 26 is positioned to be aligned with the dust passage 5a side by side in the left-right direction when the dust box 20 is attached to the fixed cover 5. The front engaging portion 26 is approximately a rectangular-shaped through hole. The front engaging portion 26 penetrates the first side surface 21a in the left-right direction. The fixed cover 5 has a front engaged portion (projection) 5c protruding leftward on the left side of the dust passage 5a. The front engaging portion 26 and the front engaged portion 5c engage with each other through a recess/protrusion fitting structure. The front side engaged portion 5c is triangular in cross-section when viewed in the front-rear direction. The front engaged portion 5c includes a peak portion protruding most in the leftward direction at a center in the up-down direction. Also, the front engaged portion 5c includes an upper tapered surface 5d above the center in the up-down direction and a lower tapered surface 5e below the center in the up-down direction. The upper tapered surface 5d is tilted upward as it extends from the center in a rightward direction. The lower tapered surface 5e is tilted downward as it extends from the center in the rightward direction.

As shown in FIGS. 2, 5, 9, and 10, the rear engaging portion 27 is positioned to be aligned with an upper rear end portion of the fixed cover 5 side-by-side in the left-right direction when the dust box 20 is attached on the fixed cover 5. The rear engaging portion 27 is formed in an adjoining area of an upper surface of the dust box 20. The rear engaging portion 27 rotates in the left-right direction like a lever. The rear engaging portion 27 has a pushable portion 27a at an upper portion thereof. The pushable portion 27a can be pushed rightward by a finger or the like of a user. The rear engaging portion 27 has an engaging portion 27c at a lower portion thereof. The engaging portion 27c has a hooked shape protruding rightward. The pushable portion 27a and the engaging portion 27c are integrally connected with each other by an arm 27b extending in the up-down direction.

As shown in FIG. 5, a rotation shaft 27e is arranged in the center of the arm 27b in the up-down direction. A compression spring 27d is disposed on a right side of the pushable portion 27a. The compression spring 27d biases the rear engaging portion 27 leftward in a direction opposite to the push direction. When the pushable 27a is pushed rightward, the rear engaging portion 27 rotates around the rotation shaft 27e. Accordingly, the engaging portion 27c moves leftward. When the pushing operation is stopped, the rear engaging portion 27 rotates such that the pushable portion 27a moves leftward by the biasing force of the compression spring 27d. Accordingly, the engaging portion 27c moves rightward.

As shown in FIGS. 5 and 10, an upper rear end portion of the fixed cover 5 includes a flange having a concave-shaped rear engaged portion 5f on a left side surface of the fixed cover 5. The rear engaged portion 5f has a trapezoidal shape with an upper portion larger than a lower portion viewed from in the left-right direction. The engaging portion 27c of the rear engaging portion 27 enters the rear engaged portion 5f from the left to the right when the dust box 20 is attached to the fixed cover 5. The engaging portion 27c is retractable from the rear engaged portion 5f from the right to the left when the dust box 20 is removed from the fixed cover 5.

Next, a method how to attach and detach the dust box 20 to and from the fixed cover 5 will be explained below with reference to FIGS. 2 to 10. The dust box 20 can be attached and detached to and from the fixed cover 5 by holding the rear portion of the dust box 20 with one hand while holding the left and right sides of the dust box 20 using a thumb and other fingers as shown in, for example, FIG. 5. When attaching the dust box 20 to the fixed cover 5, the dust box 20 is lowered to the fixed cover 5 from above. In more detail, the dust box 20 is lowered toward the fixed cover 5 such that the first side surface 21a of the dust box 20 slides along a left side surface of the fixed cover 5. The front engaged portion 5c gradually enters the front engaging portion 26 while a lower end of the front engaging portion 26 slides along an upper tapered surface 5d of the fixed cover 5. Owing to the slide movement, a resistance force can be suppressed when the front engaging portion 26 engages the front engaged portion 5c. This allows the front engaging portion 26 and the front engaged portion 5c to engage with each other smoothly while holding the rear part of the dust box 20 with one hand.

The user holds the dust box 20 while pressing the pushable portion 27a with the finger. The rear engaging portion 27 rotates against the biasing force of the compression spring 27d to move leftward. When the front engaging portion 26 engages the front engaged portion 5c, the pushing operation of the engaging portion 27c is stopped in a state where the engaging portion 27c is aligned with the rear engaged portion 5f side by side in the left-right direction. The rear engaging portion 27 rotates by the biasing force of the compression spring 27d. The engaging portion 27c moves rightward to engage the rear engaged portion 5f. In this manner, the user can attach the dust box 20 to the fixed cover 5 only by holding the dust box 20 and operating the pushable portion 27a.

When the dust box 20 is removed from the fixed cover 5, the user holds the dust box 20 in the left-right direction with one hand while pressing the pushable portion 27a with the fingers. The rear engaging portion 27 rotates against the biasing force of the compression spring 27d. The engaging portion 27c moves leftward from the rear engaged portion 5f. This allows the rear portion of the dust box 20 to be lifted upward. The front engaged portion 5c gradually disengages from the front engaging portion 26 while the lower end of the front engaging portion 26 slides along the lower tapered surface 5e of the fixed cover 5. Owing to the slide movement, a resistance force can be suppressed when the front engaging portion 26 disengages from the front engaged portion 5c. This makes it possible to smoothly disengage the front engaging portion 26 from the front engaged portion 5c while holding the rear part of the dust box 20 with one hand. In this way, the user can remove the dust box 20 from the fixed cover 5 only by holding the dust box 20 and operating the pushable portion 27a.

As shown in FIG. 13, a stand 30 has a base 31 such that workpiece W can be placed on a table surface 31a of the base 31. The table surface 31a is formed in a planar shape extending in a horizontal direction. Legs 31b are arranged at four corners of the base 31. The base 31 is placed on an installation surface such as a floor surface by the four legs 31b. An opening 31c is formed in a right area of the table surface 31a. The opening 31c is a long through-hole extending in a direction from a user side to a side opposite to the user side, which is hereinafter referred to as the depth direction. When the portable cutting device 1 attached to the stand 30 swings downward, the cutting blade 4 of the cutting device main body 10 and a dust guide 45 attached to the cutting device main body 10 enter the opening 31c. The dust guide 45 will be discussed later in detail.

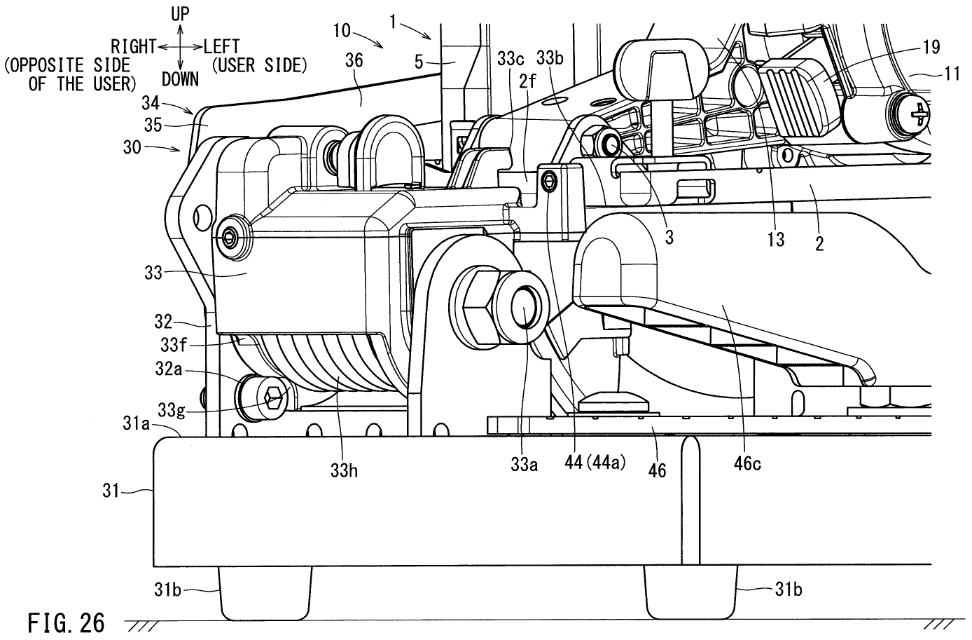

As shown in FIGS. 1, 14, and 16, a swing support 32 is arranged on the table surface 31a and on a side opposite to the user with regard to the base 31. The swing support 32 supports the portable cutting device 1 attached to the stand 30 so as to be swung in the up-down direction. A bolt 32a is attached to the swing support 32 extending in the leftward direction. The bolt 32a serves as a top dead center stopper and a bottom dead center stopper of the portable cutting device 1 when swung in the up-down direction (refer to FIG. 26).

As shown in FIGS. 13, 14, and 16, a fence 46 is arranged on the table surface 31a to position the workpiece W. The fence 46 has a contact surface 46a that contacts the workpiece W. The contacting surface 46a is a flat surface 46a facing a side of the user and is erected in the up-down direction. A rotation shaft 46b of the fence 46 is arranged in the adjoining area of the opening 31c. The fence 46 rotates horizontally about the rotation shaft 46b of the fence 46, sliding against the table surface 31a of the base 31. Because of this configuration, an angle of the contact surface 46a can be changed in the left-right direction perpendicular to the cutting blade 4. For example, when the contact surface 46a is perpendicular to the cutting blade 4, the cutting angle is 0°. In this case, the workpiece W contacting the contact surface 46a of the fence 46 is cut at right angle by the cutting blade 4 (perpendicular cutting). For another example, when the contact surface 46a is inclined at 45° with respect to the cutting blade 4 in the leftward direction on the opposite side of the user, the cutting angle is 45°. In this case, the workpiece W contacting the contact surface 46a of the fence 46 is cut at an angle of 45° with respect to the cutting blade 4 (oblique cutting, or miter cut).

As shown in FIGS. 13, 14, and 16, the fence 46 has a lever 46c that is disposed on the opposite side of the user rather than the contact surface 46a. The lever 46c is rotatable horizontally. When the lever 46c is rotated in a tightening direction, the fence 46 is pushed toward the table surface 31a. This firmly presses and secures the fence 46 to the table surface 31a. When lever 46c is rotated in a loosening direction, the pressing force pushing fence 46 toward the table surface 31a is released. Accordingly, the fence 46 can be rotated around the rotation shaft 46b.

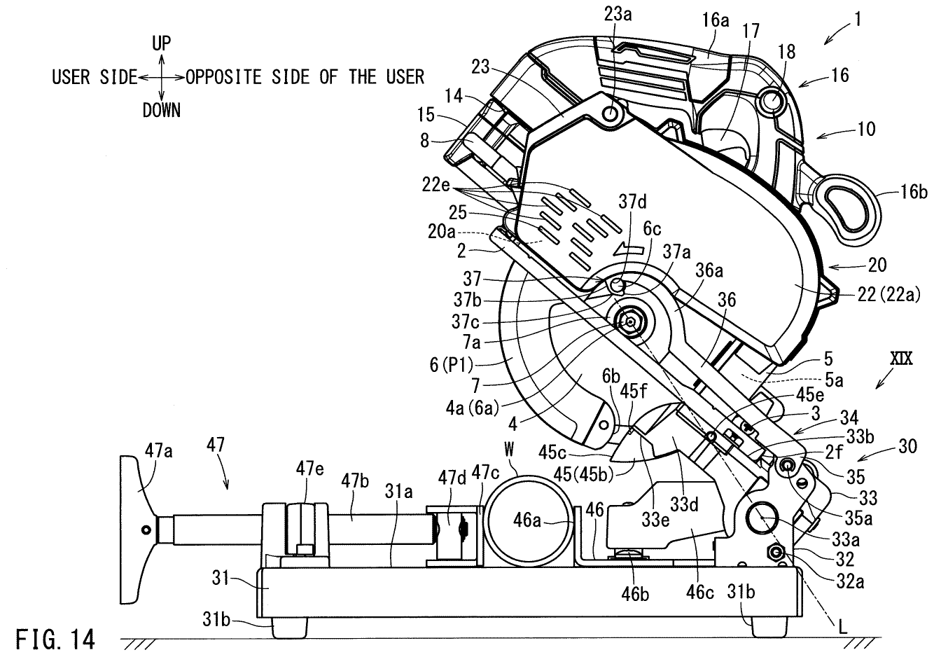

As shown in FIGS. 13 and 14, a vise device (lateral vise) 47 is arranged on the table surface 31a of the base 31. The vise device 47 has a vise plate 47c slidable in a depth direction on the user side rather than the fence 46. The vise plate 47c is rotatably connected to a feed screw 47b extending toward the user side. The vise plate 47c is rotatable around a rotation shaft 47d extending in a direction perpendicular to the depth direction. The vise plate 47c is thus rotatable such that the vise plate 47c on the opposite side of the user faces the contact surface 46a of the fence 46. The feed screw 47b threadedly engages a vise base 47e placed on the base 31 on the user side. A feed handle 47a is integrally formed in the feed screw 47b on the user side. By rotating the feed handle 47a, the vise plate 47c can be moved in the depth direction. By holding the workpiece W between the contact surface 46a of the fence 46 and the vise plate 47c, the workpiece W placed on the table surface 31a can be firmly held with respect to the base 31.

As shown in FIGS. 14 to 17, 26, the stand 30 has an attachment arm 33 that can be swung in the up-down direction with respect to the swing support 32. The attachment arm 33 connects to the swing support 32 at a swing center 33a. The attachment arm 33 is formed in a flat plate shape extending from the swing center 33a toward the user side. The attachment arm 33 swings in the up-down direction around the swing center 33a. A top dead center contact portion 33f and a bottom dead center contact portion 33g are arranged in the attachment arm 33 on the opposite side of the user (refer to FIG. 26). When the top dead center contact portion 33f contacts the bolt 32a, the arm 33 stops swinging further upward at the top dead center. On the other hand, when the bottom dead center contact portion 33g contacts the bolt 32a, the arm 33 stops swinging further downward at the bottom dead center. The attachment arm 33 is constantly biased toward the top dead center by a torsion spring 33h disposed around the swing center 33a. The portable cutting device 1 can be detachably attached to the stand 30 by placing the base 2 of the portable cutting device 1 on an upper surface 33b of the attachment arm 33.

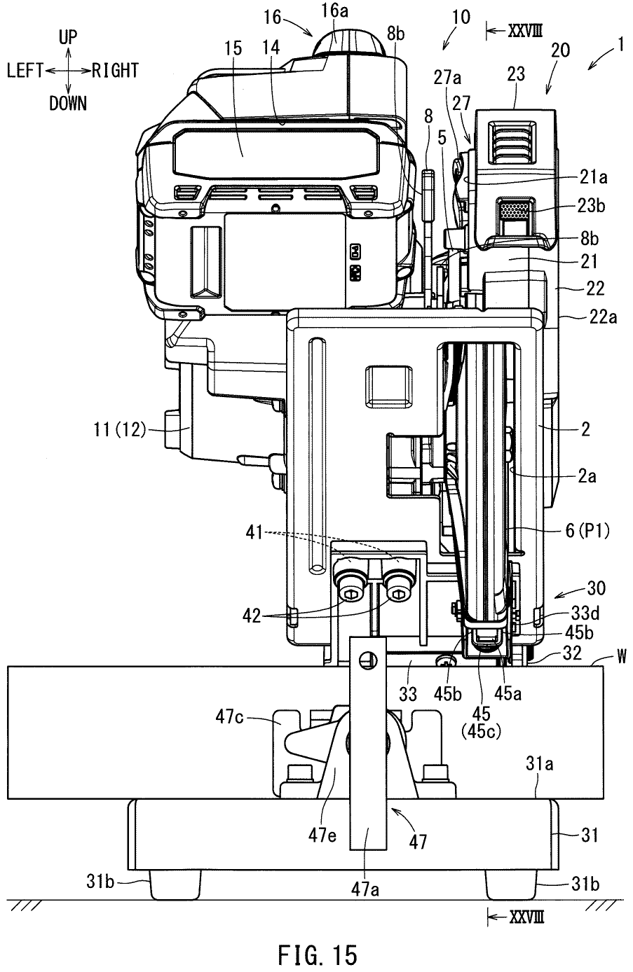

As shown in FIGS. 15, 17 to 20, two nuts 41 are disposed on the left side of the attachment arm 33 on the user side. An upper portion of each of the two nuts 41 protrudes upward above the upper surface 33b of the attachment arm 33. The two nuts 41 are aligned in the same position in the depth direction and apart from each other in the left-right direction at a predetermined interval. Each of the nuts 41 is inserted into a through hole penetrating through the attachment arm 33 in the thickness direction. The upper portion of each nut 41 has an enlarged diameter portion 41a than a lower portion thereof. The enlarged diameter portion 41a of each nut 41 is disk-shaped and extends parallel to the upper surface 33b of the attachment arm 33. The lower portion of the nut 41 has a diameter configured to insertable to the circular hole 2b and the narrow width hole 2c of the base 2. On the other hand, the enlarged diameter portion 41a of the nut 41 has a diameter configured to be insertable to the circular hole 2b but not into the narrow width hole 2c. A bolt (screw member) 42, which is inserted upward from a lower surface side of the attachment arm 33, is attachable to the lower part of the nut 41. The nut 41 is biased toward the upper surface 33b of the attachment arm 33 by a biasing member 41b (compression spring) which is placed inside of the attachment arm 33. Because of this configuration, a clearance, for example, almost as thick as the base 2 is maintained between a lower surface of the enlarged diameter portion 41a and the upper surface 33b of the attachment arm 33.

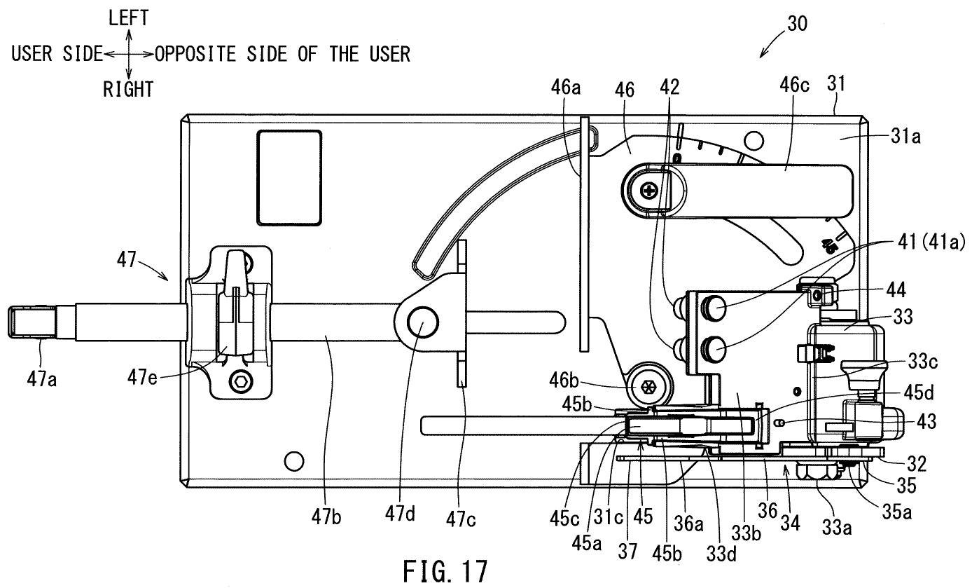

As shown in FIGS. 17 to 20, a pin 43 is formed on the right side of the upper surface 33b of the attachment arm 33. The pin 43 protrudes upward from the upper surface 33b of the attachment arm 33 extending in a direction perpendicular to the upper surface 33b. The pin 43 is positioned at the same position in the left-right direction as a center of the dust guide 45 in the left-right direction. The pin 43 is formed in a cylindrical shape having a diameter configured to be insertable into the hole 2d and the narrow width portion 2e of the base 2 of the portable cutting device 1. The attachment arm 33 has a contact surface 33c that extends in the left-right direction and in a direction approximately perpendicular to the upper surface 33b of the attachment arm 33. The contact surface 33c contacts the front surface 2f of the base 2 of the portable cutting device 1 to restrict further movement of the base 2 toward the opposite side of the user. An adjustment screw 44 is arranged at a left portion of the attachment arm 33 on the opposite side of the user. The adjustment screw 44 penetrates through the contact surface 33c. A distal end of the adjustment screw 41 faces toward the user side. The distal end of the adjustment screw 44 can contact the front surface 2f of the base 2. The adjustment screw 44 has an operation portion 44a on the opposite side of the user, which is turnable by, for example, a screwdriver. By tightening or loosening the operation part 44a, a protruding length of the adjustment screw 44 toward the user side can be fine-adjusted.

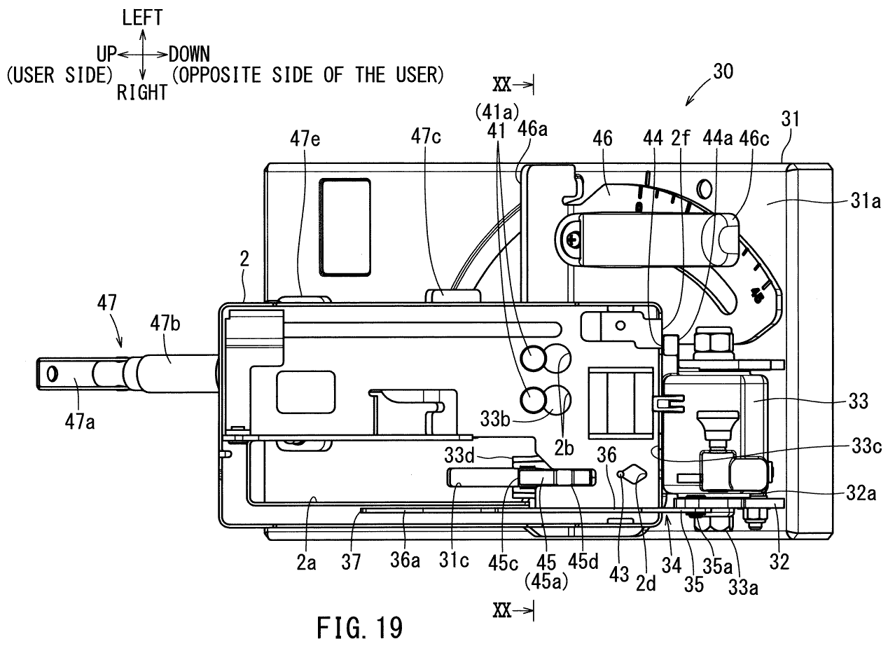

Next, a method how to attach and detach the base 2 of the portable cutting device 1 to and from the attachment arm 33 of the stand 30 will be explained below with reference to FIGS. 1 to 20. For convenience of the explanation, FIGS. 18 and 19 only show the base 2 of the portable cutting device 1 and do not show the entirety of the portable cutting device 1. When the base 2 is attached and detached to and from the attachment arm 33 in an actual attachment/detachment procedure, the base 2 is included in the portable cutting device 1. Furthermore, when the base 2 of the portable cutting device 1 is attached to the attachment arm 33 of the stand 30, the cutting blade 4 of the portable cutting device 1 is previously locked to the bottom dead center. At first, the user holds the main handle 16a of the portable cutting device 1 such that the front surface 2f of the base 2 of the portable cutting device 1 faces toward the opposite direction of the user. The base 2 is placed on the upper surface 33b of the attachment arm 33 that is tilted upward toward the user side in a state where the attachment arm 33 is at a top dead center with respect to the base 31. At this time, the two nuts 41 are inserted into the two circular holes 2b of the base 2, respectively, and the enlarged diameter portions 41a of the two nuts 41 are set to protrude above the base 2. Also, the pin 43 is inserted into the hole 2d of the base 2.

Next, the base 2 is slid downward along the upper surface 33b of the attachment arm 33 toward the opposite side of the user. This causes the nuts 41 to enter the narrow width hole 2c and the enlarged diameter portions 41a of the nuts 41 are positioned above the narrow width holes 2c. Also, the pin 43 enters the narrow width portion 2e. At this time, when a length of the adjustment screw 44 protruding toward the user is fine-adjusted by operating the operation portion 44a, the base 2 rotates by a minute angle around the pin 43. This allows the fine adjustment of a miter angle of the base 2 relative to the attachment arm 33.

After fine-adjusting the miter angle of the base 2, the two bolts 42 are rotated in the fastening direction from the lower side of the attachment arm 33 on the opposite side of the user. As the bolts 42 and the nuts 41 are tightened with each other, the nuts 41 move downward relative to the upper surface 33b of the attachment arm 33 against the biasing force of the biasing member 41b. Accordingly, a force, by which the enlarged diameter portion 41a of the nuts 41 and the attachment arm 33 hold the base 2 of the portable cutting device 1 in the up-down direction, becomes strong enough to firmly hold the base 2. Because of this configuration, the base 2 of the portable cutting device 1 is fixable to the attachment arm 33. To remove the base 2 from the attachment arm 33, it is necessary to disengage a link arm 34 from the movable cover 6 before removing the base 2 of the portable cutting device 1 from the attachment arm 33. The link arm 34 and a combination of the link arm 34 with the movable cover 6 will be discussed later in detail. After the disengagement of the link arm 34 from the movable cover 6, the two bolts 42 are rotated in a loosening direction. While holding the main handle 16a of the portable cutting device 1, the user slides the base 2 of the portable cutting device 1 along the upper surface 33b of the attachment arm 33 in the upward direction toward the user side. Then, the user lifts the portable cutting device 1 upward and removes the nut 41 from the circular hole 2b and the pin 43 from the hole 2d. The portable cutting device 1 is then entirely removed from the stand 30.

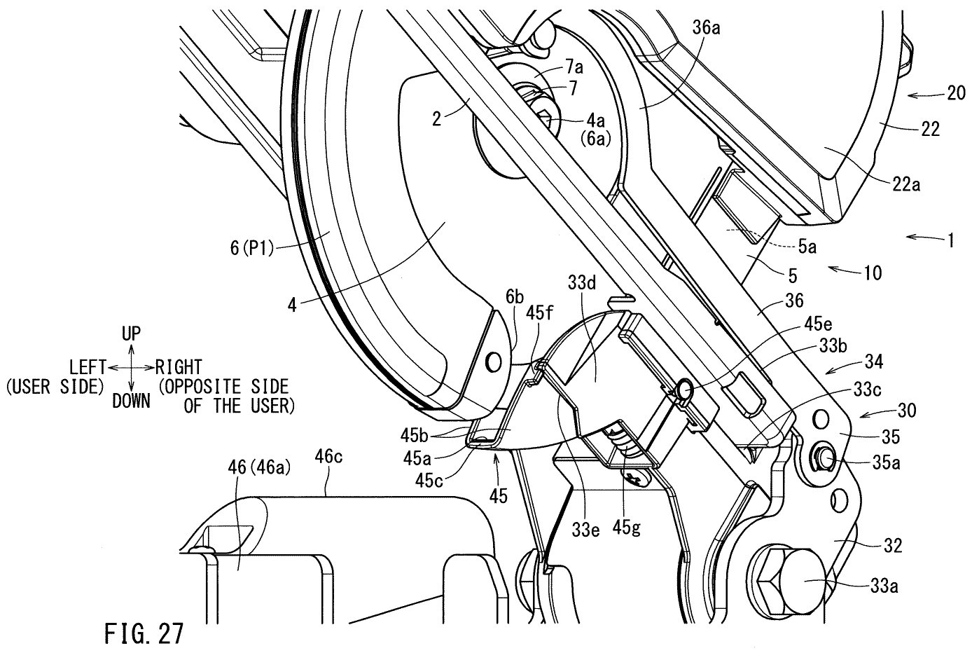

As shown in FIGS. 14, 15, 27, and 28, the stand 30 has a dust guide 45 that guides upward the sparks and cutting dusts generated during a cutting work of the workpiece W. The dust guide 45 is connected to the lower portion of the attachment arm 33. The dust guide 45 has an arc-shaped surface 45a that follows an outer circumferential edge of the movable cover 6. The arc-shaped surface 45a extends in an arc shape from an inlet end 45c on the user side to an outlet end 45d on the opposite side of the user. The inner wall of the arc-shaped surface 45a is covered with a sheet metal to prevent abrasion of the inner wall caused by the sparks and cutting dusts. The dust guide 45 includes a pair of side surfaces 45b. A left side of the arc-shaped surface 45a is connected to the side surface 45b on the left side, and a right side of the arc-shaped surface 45a is connected to the side surface 45b on the right side. The pair of side surfaces 45b are erected in the up-down direction and extend parallel to each other in the depth direction. The inlet end 45c faces the end portion 6b of the movable cover 6 in the closed position P1 in the depth direction. The movable cover 6 in the closed position P1 and the gust guide 45 cooperate to cover the lower area of the cutting blade 4. The outlet end 45d is connected to the lower end of the dust passage 5a of the fixed cover 5 (refer to FIG. 27). Because of this configuration, the sparks and cutting dusts flowing along the arc-shaped face 45a of the dust guide 45 to the outlet end 45d can be guided upward to the passage 5a without scattering the sparks and cutting dusts around the portable cutting device 1.

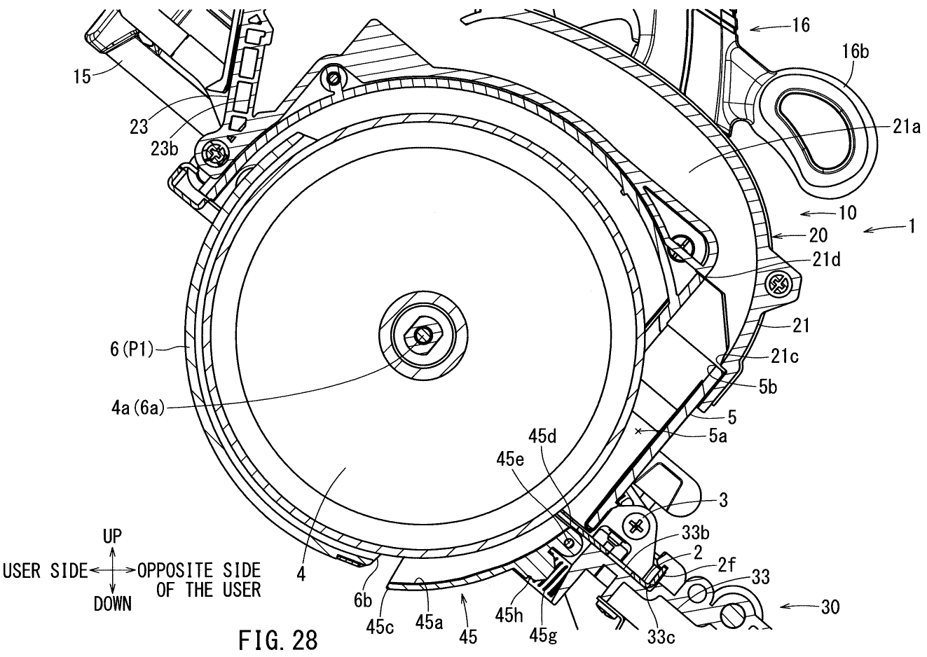

As shown in FIGS. 14, 27, and 28, the dust guide 45 is connected to the attachment arm 33 so as to be rotatable around a rotation shaft 45e on the opposite side of the user. As shown in FIG. 28, a spring receiving portion 45h is formed approximately below the rotation shaft 45e protruding toward the opposite side of the side. A biasing member 45g (compression spring) is placed between the spring receiving portion 45h and the lower portion of the attachment arm 33. The dust guide 45 is biased upward toward the user side by the biasing member 45g. The attachment arm 33 has a guide cover 33d. The guide cover 33d extends downward from the lower surface of the attachment arm 33. The guide cover 33d covers the upper portions of the pair of side surfaces 45b from outside in the left-right direction. A lower surface 33e of the guide cover 33d extends approximately parallel to a direction in which the attachment arm 33 extends. Each of the pair of side surfaces 45b has a stopper 45f protruding outward from the left side and the right side, respectively. When the stopper 45f contacts the lower surface 33e of the guide cover 33d, the dust guide 45 cannot rotate further upward on the user side.

When replacing the cutting blade 4 while the portable cutting device 1 remains attached to the stand 30, the dust guide 45 covers a part of the lower area of the cutting blade 4. If the dust guide 45 is fixed to the attachment arm 33, the dust guide 45 may interfere with a replacement work of the cutting blade 4. However, the dust guide 45 of the present disclosure can be moved on the opposite side of the user with respect to the portable cutting device 1. For example, during a replacement/attachment work of the cutting blade 4, the cutting blade 4 can be removed outside or inserted inside of the fixed cover 5 without an interference of the dust guide 45 by pushing and moving the dust guide 45 toward the opposite side of the user by utilizing an outer circumferential edge of the cutting blade 4. This improves workability of the replacing work of the cutting blade 4. The dust guide 45 is always biased in a direction toward the cutting blade 4 by the biasing member 45g. Accordingly, the dust guide 45 can sufficiently prevent the sparks and cutting dusts from scattering when the cutting blade 4 cuts the workpiece W.

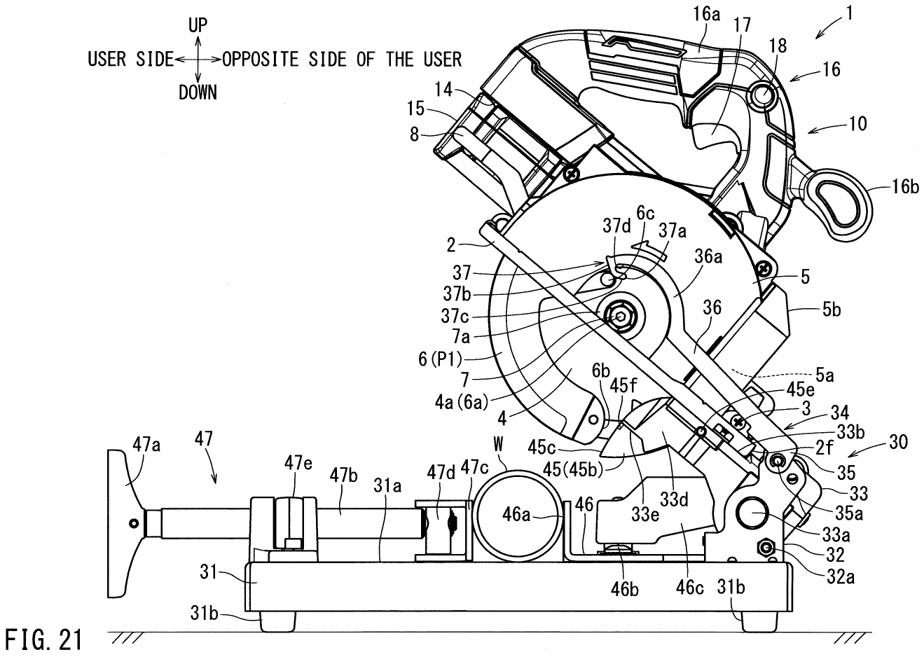

As shown in FIGS. 21 to 23, the stand 30 has the link arm 34 that releasably engages the movable cover 6. The link arm 34 is flat and extends in the up-down direction and in the depth direction on the right side of the cutting blade 4. The link arm 34 has a base portion 35, an arm main body 36, and an end portion 37. The link arm 34 connects to an upper portion of the swing support 32 so as to be rotatable around a rotation center 35a of the base portion 35 of the link arm 34. The rotation center 35a of the link arm 34 is positioned above the swing center 33a of the attachment arm 33 and slightly on the opposite side of the user. The rotation center 35a of the link arm 34 is positioned above an imaginary straight line L passing through the swing center 33a of the attachment arm 33 and the rotation center 6a of the movable cover 6, when viewed in the left-right direction. The arm main body 36 extends from the base portion 35 toward the user side. The end portion 37 is formed on the user side of the arm main body 36.

As shown in FIGS. 21 to 23, the arm main body 36 extends straight from the base portion 35 to the adjoining area of the rotation center 4a of the cutting blade 4. An arc-shaped portion 36a is formed on the user side of the arm main body 36. The arc-shaped portion 36a curves upward to avoid the surrounding of the rotation center 4a of the cutting blade 4. Because of this configuration, in a state where the portable cutting device 1 remains attached to the stand 30, the cutting blade 4 can be exchanged by removing and attaching the fixing screw 7 without interference of the link arm 34.

As shown in FIGS. 21 to 23, the end portion 37 is hook-shaped and extends from the arc-shaped portion 36a downward on the user side and bending further toward a tip end edge 37a on the opposite side of the user. The end portion 37 overlaps the engaging portion 6c of the movable cover 6 in the left-right direction. Accordingly, the end portion 37 is engageable with the engaging portion 6c. An inclined portion 37b and a large-inclined portion 37c are formed on an outer circumferential side of the end portion 36. The large-inclined portion 37c connects to the tip end edge 37a. The inclined portion 37b is far from the tip end edge 37a than the large-inclined portion 37c. The inclined portion 37b is inclined toward the base portion 35 on the opposite side of the user. The large-inclined portion 37c is further inclined downward toward the base portion 35 on the anti-user side than the inclined portion 37b. The inclined portion 37b is inclined toward the rotation center 35a of the link arm 34 against a direction in which the movable cover 6 rotates to open. The large-inclined portion 37c is inclined further than the inclined portion 37b toward the rotation center 35a of the link arm 34 against the direction in which the movable cover 6 rotates to open. An arc-shaped inner circumference 37d is formed on the inner circumference of the end portion 37. The engaging portion 6c can enter the inner circumferential 37d.

Referring to FIGS. 14, 21 to 25, the following explains an engagement/disengagement of the link arm 34 with/from the movable cover 6 and an opening/closing of the movable cover 6 when the portable cutting device 1 swings in the up-down direction. In FIGS. 1 to 23, the dust box 20 is removed from the fixed cover 5 for convenience of explanation, but in an actual operation, the dust box 20 is attached to the fixed cover 5. The same is true in other embodiments. First, the base 2 is attached to the attachment arm 33. At this time, the engaging portion 6c contacts the inclined portion 37b, and thus the link arm 34 does not engage the movable cover 6 yet (refer to FIG. 21).

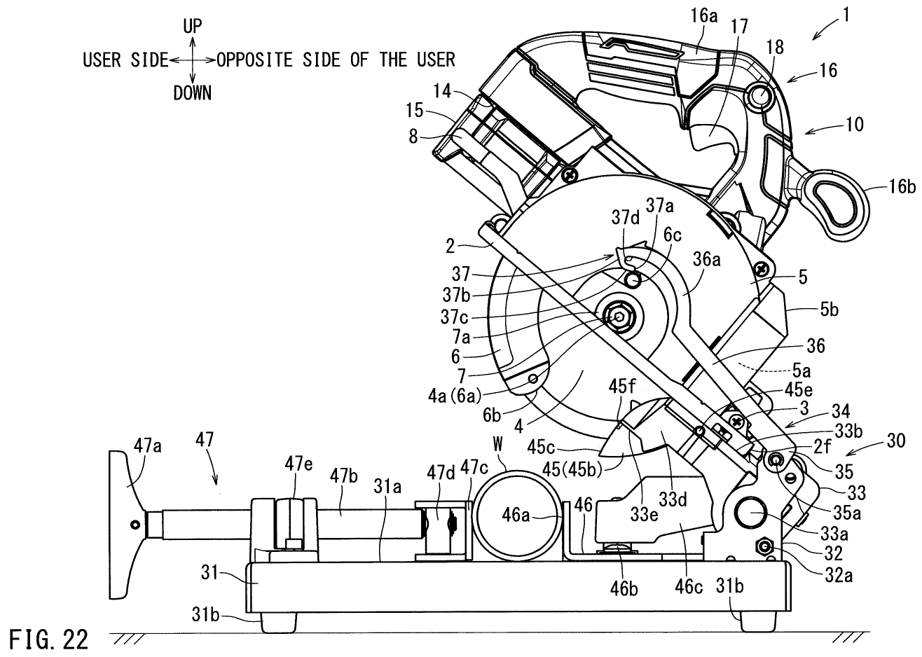

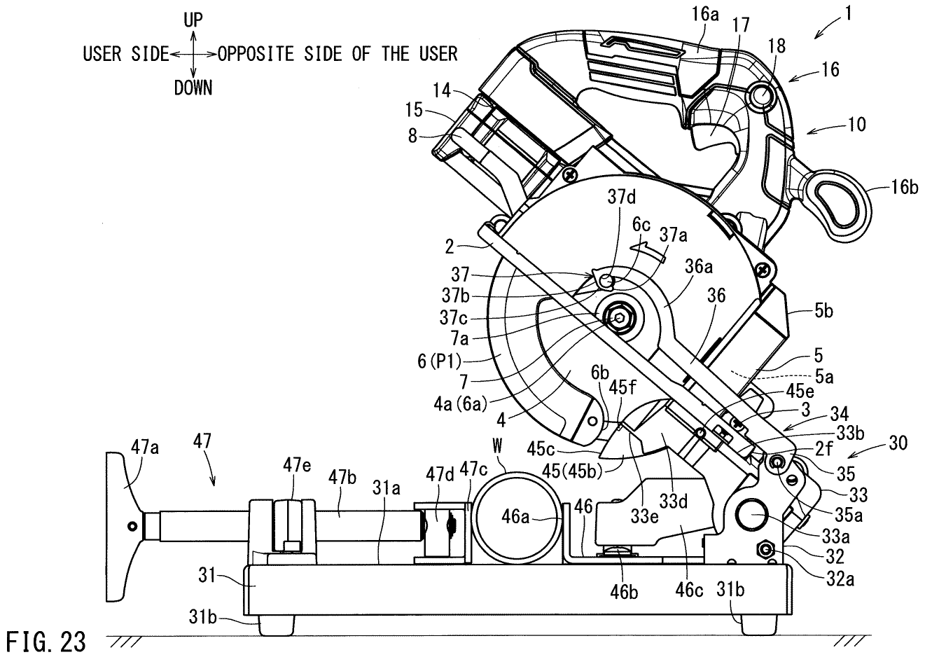

The movable cover 6 in the closed position P1 is opened in a clockwise direction in FIG. 22. The engaging portion 6c also moves in the clockwise direction around the rotation center 6a. As the engaging portion 6c moves, a contact part of the end portion 37 that contacts the engaging portion 6c also moves. Accordingly, as the movable cover 6 is opened, the engaging portion 6c slides along the inclined portion 37b, the large-inclined portion 37c, and the tip end edge 37a in this order (refer to FIG. 22). The link arm 34 slightly rotates in the up-down direction as the end portion 37 moves relative to the engaging portion 6c. When the engaging portion 6c moves over the tip end edge 37a to the opposite side of the user, the link arm 34 rotates downward. The engaging portion 6c contacts the inner circumference 37d of the end portion 37. When the movable cover 6 is returned to the closing direction in this state, the movable cover 6 closes while the engaging portion 6c is hooked to the inner circumference 37d (refer to FIG. 23). In this way, the link arm 34 engages the movable cover 6 only by opening and closing the movable cover 6. The link arm 34 can be disengaged from the movable cover 6 by rotating the movable cover 6 upward to open and then moving the link arm 34 upward.

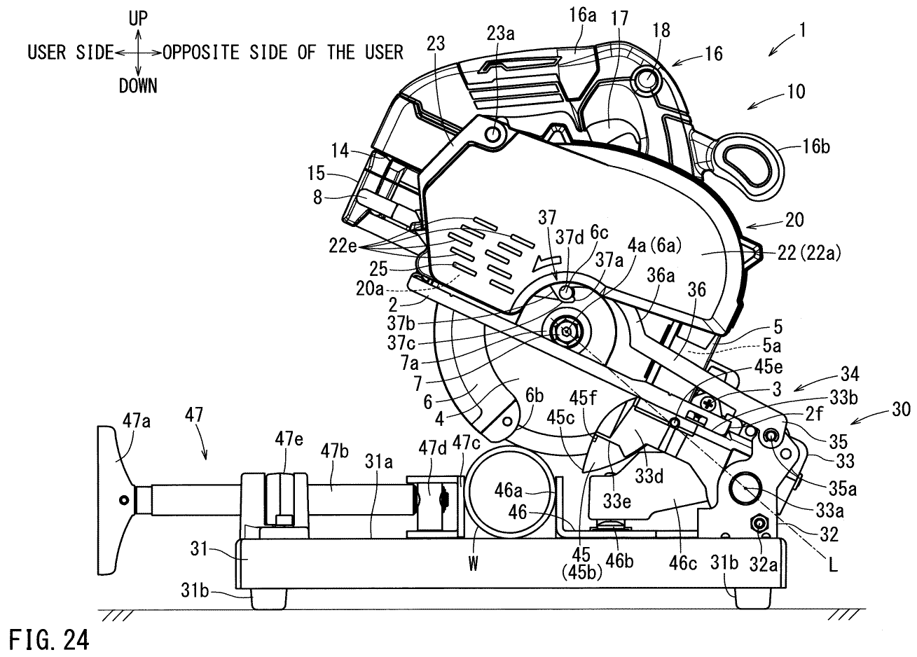

When the portable cutting device 1 is in the top dead center, the movable cover 6 is in the closed position P1. When the portable cutting device 1 and the attachment arm 33 swing in the up-down direction, the rotation center 35a of the link arm 34 and the rotation center 6a of the movable cover 6 move around the swing center 33a of the attachment arm 33. When the portable cutting device 1 swings downward, the rotation center 35a of the link arm 34 moves away from the rotation center 6a of the movable cover 6. Accordingly, as the portable cutting device 1 swings downward, the link arm 34 pulls the engaging portion 6c toward the opposite side of the user. Because of this configuration, the movable cover 6 rotates in a clockwise direction in FIG. 24 to open.

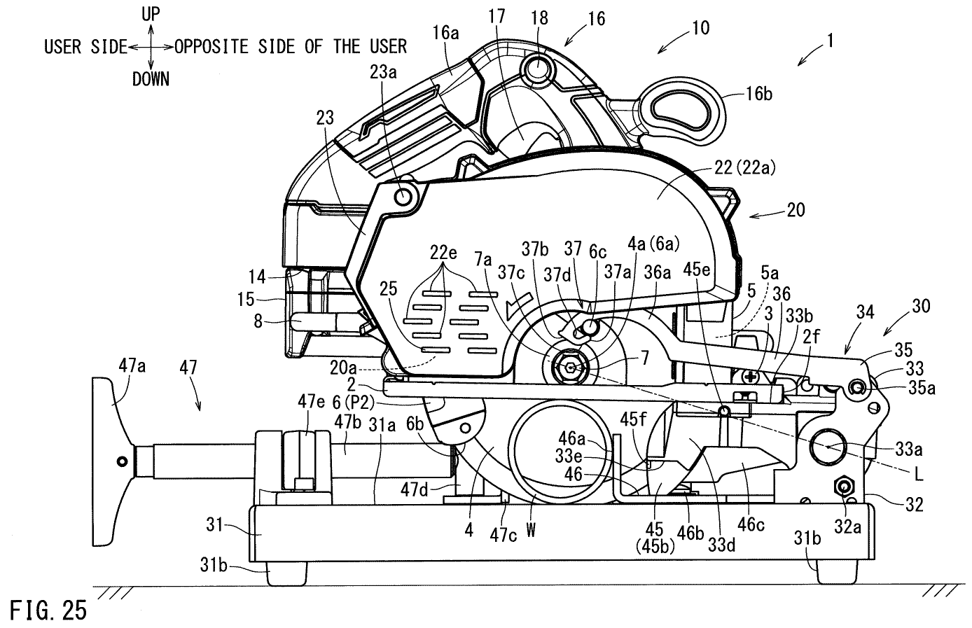

By moving the portable cutting device 1 downward to a predetermined length, the movable cover 6 exposes a part of the lower area of the cutting blade 4. This allows the cutting blade 4 to cut into the workpiece W (refer to FIG. 24). When the portable cutting device 1 is moved downward to the bottom dead center, the movable cover 6 opens to an open position P2 where almost of the lower area of the cutting blade 4 is exposed (refer to FIG. 25). Because of this configuration, the movable cover 6 can be automatically opened and closed by the link arm 34 in conjunction with the swing movement of the portable cutting device 1 in the up-down direction.

As described above, as shown in FIGS. 3, 5, 7, and 10 to 12, the portable cutting device 1 for cutting metal has the cutting device main body 10 and the dust box 20 that is detachably attachable to the cutting device main body 10. The cutting blade 4 is rotatably attachable to the cutting device body main 10. The dust box 20 includes the first housing 21, the second housing 22, and the inner plate 25. The first housing 21 is made of synthetic resin having the first side surface 21a arranged inside of the cutting device body main 10. The second housing 22, which is connected to the first housing 21 with each other, is made of synthetic resin having the second side surface 22a opposite the first side surface 21a. The inner plate 25 is arranged through the second side surface 22a and the air layer A.

Because of this configuration, the sparks and cutting dusts, which are generated by the cutting blade 4 during a cutting work of the workpiece W, flow mainly to a side of the inner plate 25 by the rotating wind of the cutting blade 4. By arranging the air layer A between the inner plate 25 and the second side surface 22a, a heat from the sparks and cutting dusts can be suppressed from being transmitted to the second housing 22. Accordingly, the user can easily hold the dust box 20, which improves workability of the attachment and detachment of the dust box 20 to and from the cutting device main body 10.

As shown in FIGS. 5 and 7, the upper opening 20b of the dust collection chamber 20a is formed between the first side surface 21a and the inner plate 25. Accordingly, the sparks and cutting dusts can be more reliably guided into the dust collection chamber 20a. By arranging the air layer A between the inner plate 25 and the second side surface 22a, the dust collection chamber 20a is thermally protected in a degree that the second side surface 22a does not become too hot for the user to hold. Because of this configuration, the hot cutting dusts can be housed in the dust collection chamber 20a while a good usability of the dust box 20.

The inner plate 25 shown in FIGS. 3 to 7, 11, and 12 is made of aluminum. Accordingly, the inner plate 25, which has high thermal conductivity, is prevented from localized rise in temperature. Therefore, the temperature of the inner plate 25 becomes uniform. Furthermore, the rotating wind of the cutting blade 4 blows against an entirety of the inner plate 25. Because of this configuration, the cooling efficiency of the inner plate 25 can be improved.

As shown in FIGS. 3 to 7, the inner plate 25 is uniform in thickness. Therefore, localized rise in temperature can be prevented. Accordingly, the temperature of the inner plate 25 becomes uniform.

As shown in FIGS. 3 to 7, the inner plate 25 measures about 0.3 mm to 1.0 mm in thickness. Therefore, the inner plate 25 is lightweight, and accordingly the dust box 20 can be made lightweight. Furthermore, the air layer A having a thickness larger than a predetermined length can be easily arranged between the inner plate 25 and the second side surface 22a.

The inner plate 25 shown in FIG. 3 to 7, 11, and 12 is made of aluminum with a surface emissivity of 0.2 or less. Because of the low emissivity of the inner plate 25, less heat is radiated from the inner plate 25 as electromagnetic waves even when the temperature of the inner plate 25 rises. Accordingly, the first housing 21 and the second housing 22 can be suppressed from being heated by heat radiation from the inner plate 25.

As shown in FIGS. 3 to 7, and 11, the rib (spacer) 22b integrally formed with the second housing 22 is arranged between the inner plate 25 and the second side surface 22a. Because of the presence of the rib 22b, the air layer A having a thickness larger than a predetermined length can be arranged.

As shown in FIGS. 3 to 7, and 11, the spacer 22b is the rib integrally formed with the second housing 22. Accordingly, the air layer A can be formed without increasing the number of parts. Due to the small number of parts, assemblability of the dust box 20 can be improved.

As shown in FIG. 3 to 7, the inner plate 25 is pressed against the first housing 21 by the ribs 22b. Accordingly, the inner plate 25 can be firmly held simply by holding the inner plate 25 between the ribs 22b of the second housing 22 and the first housing 21. Therefore, the dust box 20 can be assembled with a simple structure, and heat accumulation can be suppressed inside of the dust box 20.

As shown in FIGS. 10 to 12, the first housing 21, inner plate 25, and second housing 22 are integrally assembled by screwing the second housing 22 to the first housing 21. Accordingly, assemblability of the dust box 20 can be efficiently improved.

As shown in FIGS. 5, 11, and 12, the lower portion 21m of the first housing 21 and the lower portion 22g of the second housing 22 cooperate to form the bottom portion 20c of the dust collection chamber 20a of the dust box 20. Accordingly, the bottom portion 20c of the dust collection chamber 20a can be formed to prevent the cutting dusts from scattering, and assemblability of the dust box 20 can be improved

As shown in FIGS. 3 to 7, the air layer A is 0.5 mm or more in thickness. Therefore, the second side surface 22a can be suppressed from rising in temperature. Accordingly, the temperature of the outer surface of the dust box 20 can be suppressed to such a degree that, for example, the user can hold the dust box 20 without having a discomfortable feeling.

As shown in FIGS. 1, 5, and 7, the through-holes 22e that penetrate the second housing 22 toward the air layer A are formed in the second housing 22. Accordingly, an outside air flows into and out of the air layer A via the through-holes 22c. These through-holes 22c allow outside air to flow into and out of the air layer A between the inner plate 25 and the second housing 22, aiding in cooling the inner plate 25.

As shown in FIG. 12, a front port 21j, to which the cutting dusts are carried, is formed at a front portion of the dust box 20. As shown in FIG. 1, the through-holes 22e are arranged in the rear area 20e of the dust box 20 behind the rotation center 4a of the cutting blade 4. Accordingly, the sparks and cutting dusts are carried by the rotating wind of the cutting blade 4 from the front port 21j to the rear area 20e of the dust box 20 behind the rotation center 4a of the cutting blade 4. The through-holes 22e are arranged, through the air layer A, opposite to the inner plate 25 in the rear area 20e of the dust box 20 to which the sparks and cutting dusts are carried. Accordingly, the inner plate 25, which is warmed by the heat of the sparks and cutting dusts, can be efficiently cooled by the outside air flowing via the through-holes 22e.

As shown in FIGS. 2, 9, and 10, the portable cutting device 1 has the cutting device main body 10 and the dust box 20 that is removably attachable to the cutting device main body 10. The cutting blade 4 is rotatably attachable to the cutting device main body 10. The dust box 20 has the front port 21j (refer to FIG. 12), the front engaging portion 26, and the rear engaging portion 27. The cutting dusts are carried to the front port 21j. The front engaging portion 26 is removably engageable with the cutting device main body 10 in the left-right direction. The rear engaging portion 27 is removably engageable with the cutting device main body 10 in the left-right direction. An operation portion, by pushing of which the front engaging portion 26 is disengagable from the cutting device main body 10, is arranged either in the front engaging portion 26 or the rear engaging portion 27.

Because of this configuration, the dust box 20 can be firmly attached to the cutting device main body 10 at the two points, i.e., at the front engaging portion 26 and the rear engaging portion 27. Accordingly, the number of engaging portions can be reduced, which can prevent the dust box 20 from being enlarged. In addition, both the front engaging portion 26 and the rear engaging portion 27 are arranged to engage with the cutting device main body 10 in the left-right direction, and also either one is arranged as the operation portion 27 that can be pushed for operation. This prevents the dust box 20 having the front engaging portion 26 and the rear engaging portion 27 from being enlarged in the front-rear direction and in the up-down direction. Accordingly, the operativity of the dust box for attaching and detaching the dust box 20 to and from the cutting device main body 10 can be improved.

As shown in FIGS. 2 and 9, either the front engaging portion 26 or the rear engaging portion 27 is arranged on the first side surface 21a of the dust box 20 disposed inside of the device main body 10 in the left-right direction. Accordingly, the front engaging portion 26 or the rear engaging portion 27 can be arranged by the use of a dead space on an inner side of the cutting device main body 10, i.e., between the cutting device main body 10 and the dust box 20. Because of this arrangement, the dust box 20 can be prevented from being enlarged.

As shown in FIGS. 2 and 9, both the front engaging portion 26 and the rear engaging portion 27 are arranged on the first side surface 21a. Accordingly, the dust box 20 can be prevented from being enlarged by arranging both the front engaging portion 26 and the rear engaging portion 27 in the dead space on the inner side of the cutting device main body 10, i.e., between the cutting device main body 10 and the dust box 20.

As shown in FIGS. 5 and 9, the rear engaging portion 27 is the operation portion. The rear area 20e of the dust box 20 is heavier than the front area 20d because the cutting dusts are accumulated in the rear area 20e. The arrangement of the operation portion 27 in the rear area 20e of the dust box 20 allows the dust box 20 to be removed from the cutting device main body 10 for carriage of the dust box 20 in a well-balanced manner in that condition.

As shown in FIGS. 5 and 9, the operation portion 27 has a pushable portion 27a on an upper side of the operation portion 27 and an engaging portion 27c engageable with the cutting device main body 10 on a lower side of the operation portion 27, such that the pushable portion 27a is integrally formed with the engaging portion 27c. By arranging the pushable portion 27a on the upper side where heat from the cutting dusts is not easily transferred, the operability of the operation portion 27 can be improved. In addition, the operation portion 27 can be operated by pushing the pushable portion 27a while holding the dust box 20 from above. Accordingly, workability of attaching to and detaching from the dust box 20 can be improved.

As shown in FIGS. 3 and 10, either one of the front engaging portion 26 or the front engaged portion 5c of the cutting device main body 10 engageable with the front engaging portion 26 is convex, and the other is concave. Accordingly, the front engaging portion 26 and the front engaged portion 5c can be arranged in a simple structure for easy positioning of the dust box 20 and the cutting device main body 10.

As shown in FIG. 9, the distance D1 between the front engaging portion 26 and the rear engaging portions 26 in the front-read direction is larger than a half of the diameter D2 of cutting blade 4. Accordingly, because of the large distance between the front engaging portion 26 and rear engaging portion 27, the dust box 20 can be reliably positioned and firmly attached to the cutting dust main body 10 with a small number of engaging portions.

As shown in FIG. 14, and 21 to 23, the stand 30 for the portable cutting device, to which the portable cutting device 1 is attachable as described above, has the attachment arm 33, the base 31, and the link arm 34. The portable cutting device 1 is removably attachable to the attachment arm 33. The base 31 supports the attachment arm 33 so as to be swingable in the up-down direction. The link arm 34 opens and closes the movable cover 6 of the portable cutting device 1 in conjunction with the movement of the attachment arm 33 in the up-down direction. The base portion 35 of the link arm 34 is rotatably linked to the base 31. The end portion 37 of the link arm 34 releasably engages the movable cover 6.

Accordingly, the link arm 34 that opens and closes the movable cover 6 can engage the end portion 37 with the movable cover 6 by simply rotating the link arm 34 around the base portion 35. Because of this configuration, the workability of attaching the portable cutting device 1 to the attachment arm 33 can be improved.

As shown in FIGS. 14, 24, and 25, the rotation center 35a of the base portion 35 of the link arm 34 is arranged to be deviated from the swing center 33a of the attachment arm 33. Accordingly, when the attachment arm 33 swings in the up-down direction, the rotation center 35a of the base portion 35 of the link arm 34 moves relatively with regard to the portable cutting device 1. Because of this configuration, it is configured such that the link arm 34 rotates to open and close the movable cover 6 in conjunction with the swing movement of the attachment arm 33 in the up-down direction.

As shown in FIGS. 14, 24, and 25, the rotation center 35a of the base portion 35 of the link arm 34 is disposed above the imaginary straight line L that connects the rotation center 6a of the movable cover 6 and the swing center 33a of the attachment arm 33. Accordingly, as the attachment arm 33 swings downward, the rotation center 35a of the base portion 35 of the link arm 34 moves away to the opposite side of the user relative to the portable cutting device 1. Because of this configuration, the link arm 34 pulls the movable cover 6 toward the opposite side of the user to open the movable cover 6 in conjunction with the downward movement of the attachment arm 33.

As shown in FIGS. 21 to 23, the link arm 34 has the arm main body 36 that connects the base portion 35 to the end portion 37. The end portion 37 of the link arm 34 extends downward from the arm main body 36. Accordingly, it is configured such that the link arm 34 can easily engage the movable cover 6 by simply rotating the link arm 34 downward, and also the link arm 34 can be easily disengaged from the movable cover 6 by simply rotating the link arm 34 upward.

As shown in FIGS. 21 to 23, the end portion 37 has the tip end edge 37a on the opposite side of the base portion 35. The tip end edge 37a has the inclined portion 37b that inclines downward toward the base portion 35. Accordingly, when the link arm 34 rotates downward, the movable cover 6 moves upward relative to the end portion 37 while sliding against the inclined portion 37b. Because of the downward movement of the link arm 34, the end portion 37 of the link arm 34 smoothly engages the movable cover 6.

As shown in FIGS. 21 to 23, the tip end edge 37a of the end portion 37 includes a large-inclined portion 37c that extends downward from the inclined portion 37b and further inclines toward the base portion 35 and extends downward from the inclined portion 37b. Because of this configuration, the end portion 37 of the link arm 34 can engage the movable cover 6 more reliably by guiding the movable cover 6 with the inclined portion 37b and the large-inclined portion 37c.

As shown in FIGS. 18 to 20, the stand 30 for the portable cutting device, to which the portable cutting device 1 is attached, has the attachment arm 33, the base 31, the nut (protrusion) 41, and the enlarged diameter portion 41a. The base 2 of the portable cutting device 1 is removably attached to the attachment arm 33. The base 31 supports the attachment arm 33 to be swingable in the up-down direction. The nut 41 protrudes upward from the attachment arm 33. The enlarged diameter portion 41a is formed on the upper portion of the nut 41. The enlarged diameter portion 41a engages the base 2 for positioning the base 2. Because of this configuration, the base 2 can be roughly positioned with respect to the attachment arm 33 by engaging the nut 41 with the base 2. Furthermore, by engaging the enlarged diameter portion 41a with the base 2, the base 2 can be easily and reliably positioned with respect to the attachment arm 33. Accordingly, workability can be improved when the base 2 of the portable cutting device 1 is attached to and detached from the attachment arm 33.

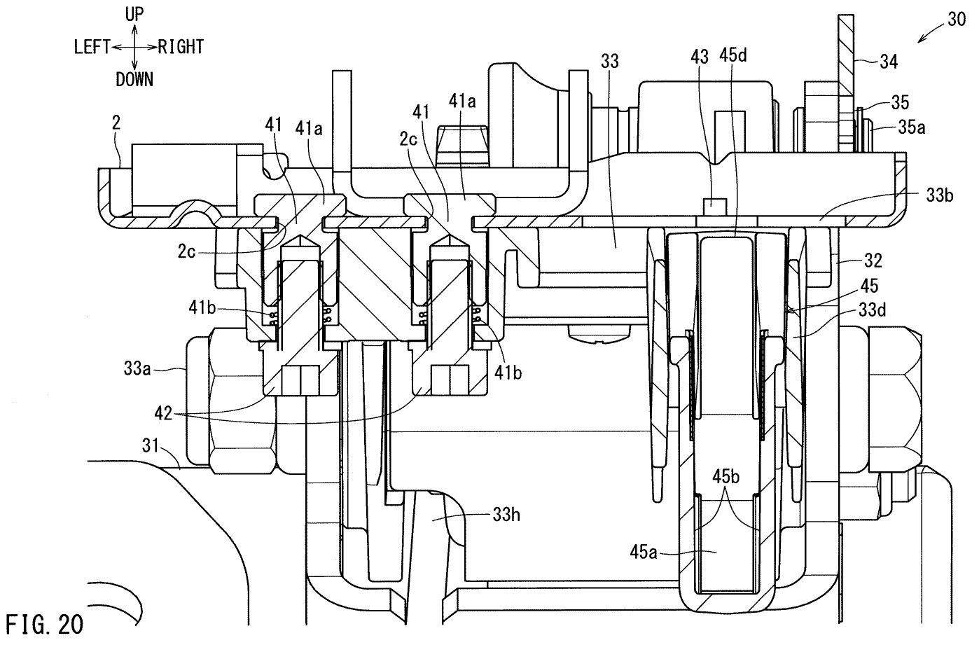

As shown in FIG. 20, the protrusion 41 is a nut that is attached to the attachment arm 33. The bolt (screw member) 42 is provided that screw-connected to the lower part of the nut 41. By tightening the bolt 42 to the nut 41, the base 2 is firmly held between the enlarged diameter portion 41a of the nut 41 and the attachment arm 33. Accordingly, the bolt 42 can be tightened to the nut 41 from below the attachment arm 33 and the base 2 in a state where the attachment arm 33 is disposed at the top dead center. Because of this configuration, an upper area of the base 2 can be prevented from being enlarged. In addition, the bolts 42 can be easily tightened or loosened from the user side which faces the lower surface of the base 2 and the attachment arm 33. Also, the center of gravity of the portable cutting device 1 can be closer to the engaging portion of the base 2 where the enlarged diameter portion 41a engages the attachment arm 33. Accordingly, durability of the base 2 against a bouncing movement of the attachment arm 33 etc. can be improved.

As shown in FIG. 20, the attachment arm 33 has the biasing member 41b that biases the nut 41 upward. Accordingly, a clearance can be provided between the enlarged diameter portion 41a of the nut 41 and the base 2 by biasing the nut 41 upward. Because of this configuration, the base 2 can be smoothly attached to or detached from the attachment arm 33.

As shown in FIGS. 18 and 19, the attachment arm 33 has the pin 43 that protrudes upward and is engageable with the portable cutter 1. Also, the attachment arm 33 has the adjustment screw 44 that protrudes toward the user side and is capable of pushing the portable cutting device 1. Because of this configuration, the portable cutting device 1 can be rotated around the pin 43 by utilizing the adjustment screw 44 in a state where the base 2 of the portable cutting device 1 is placed on the attachment arm 33. Furthermore, a tilt angle (miter angle) of the portable cutting device 1 with respect to the attachment arm 33 can be fine-adjusted according to a tightening amount of the adjustment screw 44.

As shown in FIGS. 18 and 19, the pin 43 is insertable into the hole 2d that penetrates through the base 2 of the portable cutting device 1 for placing the portable cutting device 1 in line with the marking line. Accordingly, the widely used portable cutting device 1 can be placed on the attachment arm 33 and a tilt angle (miter angle) of the portable cutting device 1 can be fine-adjusted.

As shown in FIGS. 14, 27, and 28, the stand 30 for the portable cutting device, to which the portable cutting device 1 is attached, has the attachment arm 33, the base 31, and the dust guide 45. The attachment arm 22 is removably attached to the portable cutting device 1. The base 31 supports the attachment arm 33 to be swingable in the up-down direction. The dust guide 45 protrudes approximately downward from the attachment arm 33 and extends along the cutting blade 4 of the portable cutting device 1. Accordingly, the cutting dusts generated by the cutting blade 4 during cutting of the workpiece W can be guided by the dust guide 45 toward above the attachment arm 33, for example, to the dust passage 5a inside of the fixed cover 5 of the portable cutting device 1. Because of this configuration, when the portable cutting device 1 is used as a stationary cutting device by attaching the portable cutting device 1 to the attachment arm 33, the cutting dusts can be prevented from scattering around the cutting blade 4.

As shown in FIG. 28, the dust guide 45 extends in an arc-shape along the outer circumferential edge of the cutting blade 4 on the opposite side of the user. Accordingly, the dust guide 45 cooperates with the movable cover 6 to cover the cutting blade 4. Because of this configuration, the cutting dusts can be efficiently prevented from scattering around the cutting blade 4.

As shown in FIGS. 27 and 28, the dust guide 45 is rotatably attached to the attachment arm 33 on the opposite side of the user. Accordingly, when the cutting blade 4 is replaced, the dust guide 45 can be rotated to the opposite side of the user to expose a part of the cutting blade 4. Because of this configuration, the cutting blade 4 can be more easily replaced while the portable cutting device 1 is being attached to the attachment arm 33.

As shown in FIG. 13, the base 31 has the opening 31c through which the dust guide 45 is inserted from above when attachment arm 33 swings downward. Accordingly, the dust guide 45 is prevented from interfering with the base 31. Because of this configuration, the attachment arm 33 is swingable to the bottom dead center to allow the cutting blade 4 to cut deeply into the workpiece W.

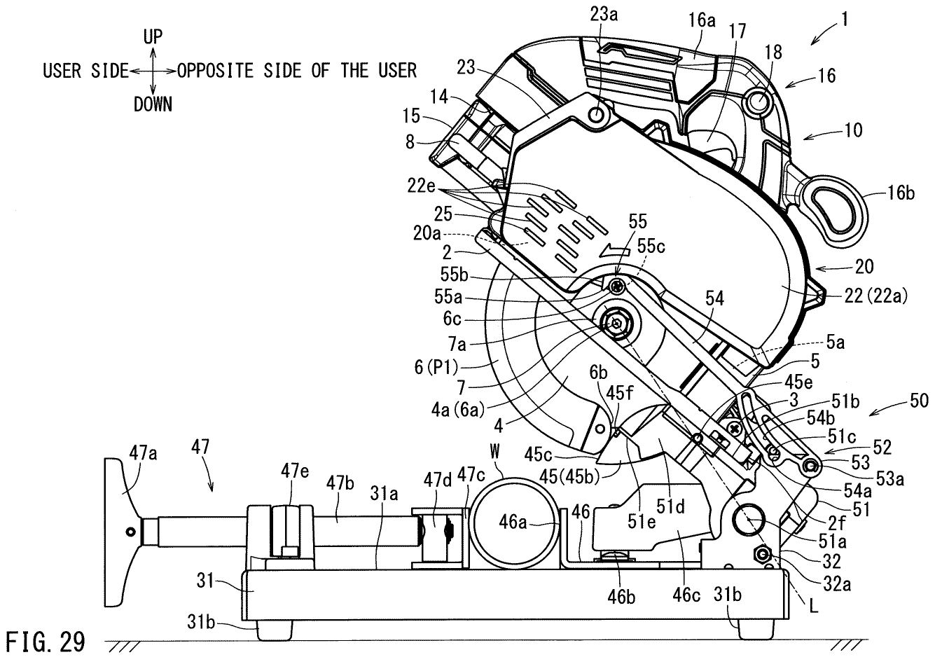

Next, a second embodiment of the present disclosure will be described with reference to FIGS. 29 to 34. A stand 50 for the portable cutting device 1 in the second embodiment has an attachment arm 51 and a link arm 52 instead of the attachment arm 33 and the link arm 34 of the stand 30 shown in FIG. 14. In the following explanation, only the members that differ from the first embodiment will be mainly described in detail.

As shown in FIGS. 29 to 32, the attachment arm 51 is formed in the same structure as that of the attachment arm 33 (refer to FIG. 14). The attachment arm 51 connects to the swing support 32 to be rotatable around a swing center 51a in the up-down direction. The base 2 of the portable cutting device 1 is placed on an upper surface 51b of the attachment arm 51. The attachment arm 51 has a guide cover 51d that covers outside of the dust guide 45 and a cover lower surface 51e that contacts the stopper 45f of the dust guide 45. The attachment arm 51 differs from attachment arm 33 in that the attachment arm 51 has a guide portion 51c above the swing center 51a. The guide portion 51c is formed in a cylindrical shape protruding in a rightward direction. The guide portion 51c engages an arm main body 54 of the link arm 52.

As shown in FIGS. 29 to 34, the link arm 52 releasably engages the movable cover 6. The link arm 52 is formed in a flat plate shape and extends in the up-down direction and in the depth direction on the right side of the cutting blade 4. The link arm 52 has a base 53, an arm main body 54, and an end portion 55. The link arm 52 is rotatably linked to an upper part of the swing support 32 around a rotation center 53a of the base 53. The rotation center 53a of the link arm 52 is positioned above an imaginary straight line L that passes through the swing center 51a of the attachment arm 51 and the rotation center 6a of the movable cover 6, viewing from the left-right direction. The arm main body 54 extends from the base 53 toward the user side. The end portion 55 is formed at the end of the arm main body 54 on the user side.

As shown in FIGS. 29 to 34, the arm main body 54 has an elongated hole 54a and an elongated hole 54b for rotation on the opposite side of the user. The elongated hole 54a and the elongated hole 54b for rotation penetrate through the arm main body 54 in the left-right direction. The elongated hole 54a and the elongated hole 54b for rotation extend in an arc shape. The elongated hole 54a extends in an arc shape approximately centering on the rotation center 53a. The elongated hole 54a and the elongated hole 54b for rotation intersect and connect with each other to form approximately in an L shape. The elongated hole 54a extends approximately in the up-down direction and is relatively short in length. The elongated hole 54b for rotation extends longer than the elongated holes 54a. The elongated hole 54b for rotation is inclined at a small inclination angle relative to the longitudinal direction of the arm body 54. Also, the elongated hole 54b for rotation extends downward toward the opposite side of the user. The guide portion 51c of the attachment arm 51 is inserted inside of the elongated hole 54a or the elongated hole 54b for rotation. The guide portion 51c slides along the elongated hole 54a or the elongated hole 54b for rotation.

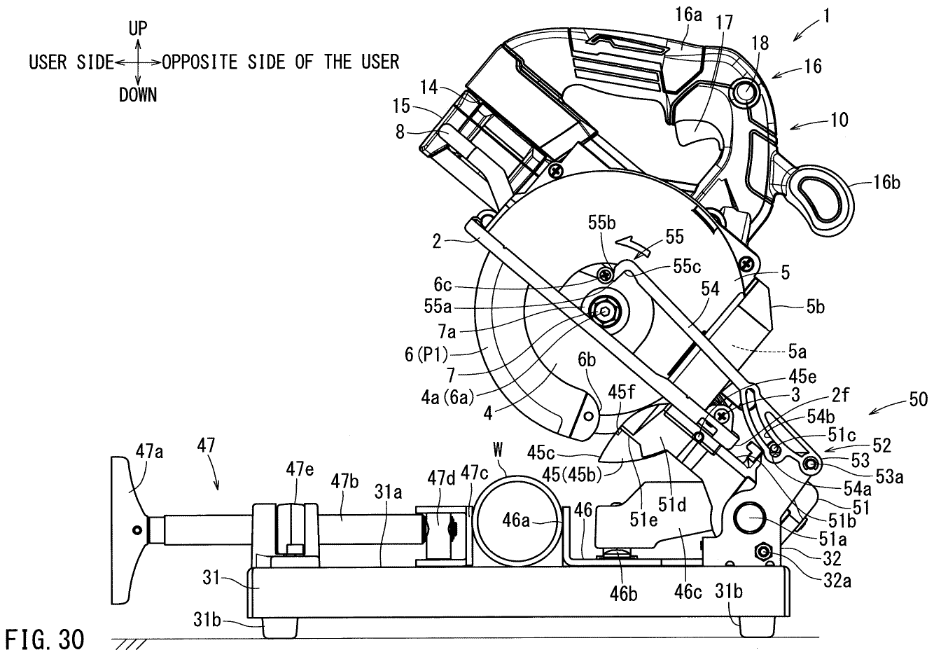

As shown in FIGS. 30 to 32, the end portion 55 is hook-shaped, bending downward approximately perpendicular to the arm main body 54. The end portion 55 overlaps the engaging portion 6c of the movable cover 6 in the left-right direction to engage the engaging portion 6c of the movable cover 6. A contact portion 55b is formed on an outer circumferential side of the end portion 55, extending to a tip end edge 55a. The contact portion 55b tilts downward relative to the extending direction of an upper surface 51b of the attachment arm 51 toward the opposite side of the user where the base 53 is located. An L-shaped inner circumferential portion 55c is formed on the inner circumferential side of the end portion 55, which is bent in an arc shape. The engaging portion 6c can enter the inner circumference portion 55c of the end portion 55.

With reference to FIGS. 29 to 34, the following explains an engagement of the link arm 52 with the movable cover 52 and an opening/closing of the movable cover 6 when the portable cutting device 1 swings in the up-down direction. First, the base 2 is placed on the upper surface 51b of the attachment arm 51. Then, each of the nuts 41 is inserted into the corresponding circular hole 2b of the base 2, and the pin 43 is inserted into the hole 2d of the base 2 (refer to FIG. 18). At this time, the front surface 2f of the base 2 has not moved to a rearmost position in the depth direction on the opposite side of the user. The engaging portion 6c contacts the contact portion 55b of the end portion 55, and the link arm 52 does not yet engage the movable cover 6. The guide portion 51c is located at a position where the elongated hole 54a intersects the elongated hole 54b for rotation (refer to FIG. 30).

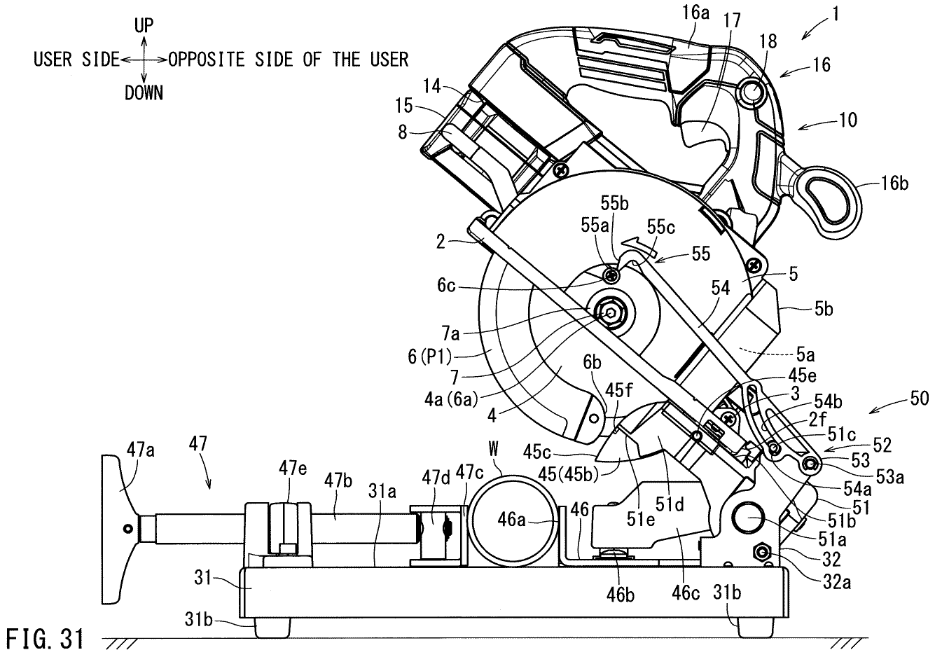

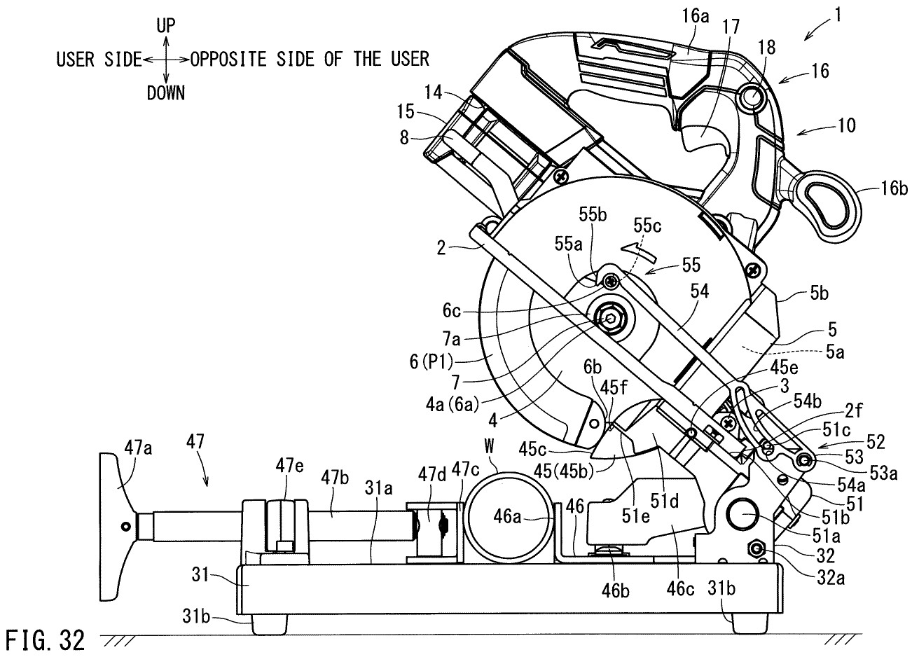

The base 2 slides downward along the upper surface 51b of the attachment arm 51 to the opposite side of the user. The engaging portion 6c moves in the extending direction of the upper surface 51b relative to the attachment arm 51. As the engaging portion 6c moves downward on the opposite side of the user, the engaging portion 6c slides along the contact portion 55b toward the tip end edge 55a (refer to FIG. 31). At this time, the guide portion 51c moves downward relative to the elongated hole 54a. Accordingly, the link arm 52 moves upward relative to the portable cutting device 1. When the engaging portion 6c moves further toward the opposite side of the user and climbs over the tip end edge 55a of the end portion 55, the end portion 55 moves downward. The guide portion 51c moves upward within the elongated hole 54a. The link arm 52 moves downward relative to the portable cutting device 1. Accordingly, the engaging portion 6c is hooked to the inner circumferential portion 55c of the end portion 55 (refer to FIG. 32). In this manner, the link arm 52 engages the movable cover 6 only by sliding the portable cutting device 1 against the attachment arm 51.

When the portable cutting device 1 is at the top dead center, the movable cover 6 is in the closed position P1 (refer to FIG. 32). When the portable cutting device 1 and the attachment arm 51 swing in the up-down direction, the rotation center 6a of the movable cover 6 move around the swing center 51a of the attachment arm 51. When the portable cutting device 1 swings downward, the rotation center 53a of the link arm 52 relatively moves away from the rotation center 6a of the movable cover 6 on the opposite side of the user. Accordingly, as the portable cutting device 1 swings downward, the link arm 52 pulls the engaging portion 6c toward the opposite side of the user. At this time, the guide portion 51c relatively moves upward on the user side within the elongated hole 54b for rotation. Accordingly, the link arm 52 is guided by the guide 51c and the elongated hole 54b to rotate around the rotation center 53a and pull the engaging portion 6c toward the opposite side of the user. Because of this configuration, the movable cover 6 rotates to open in a clockwise direction in FIGS. 32 to 34.

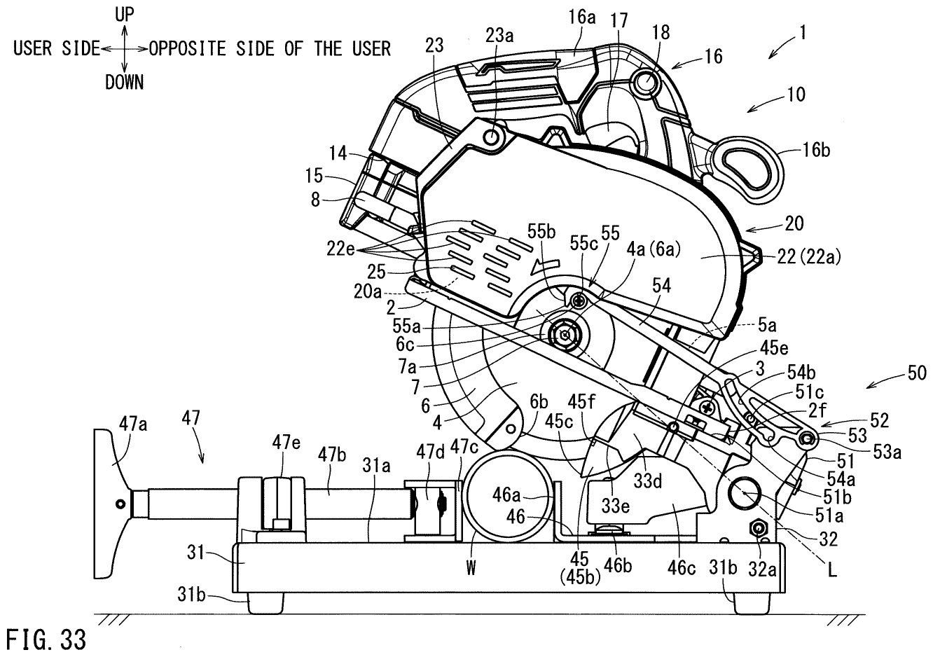

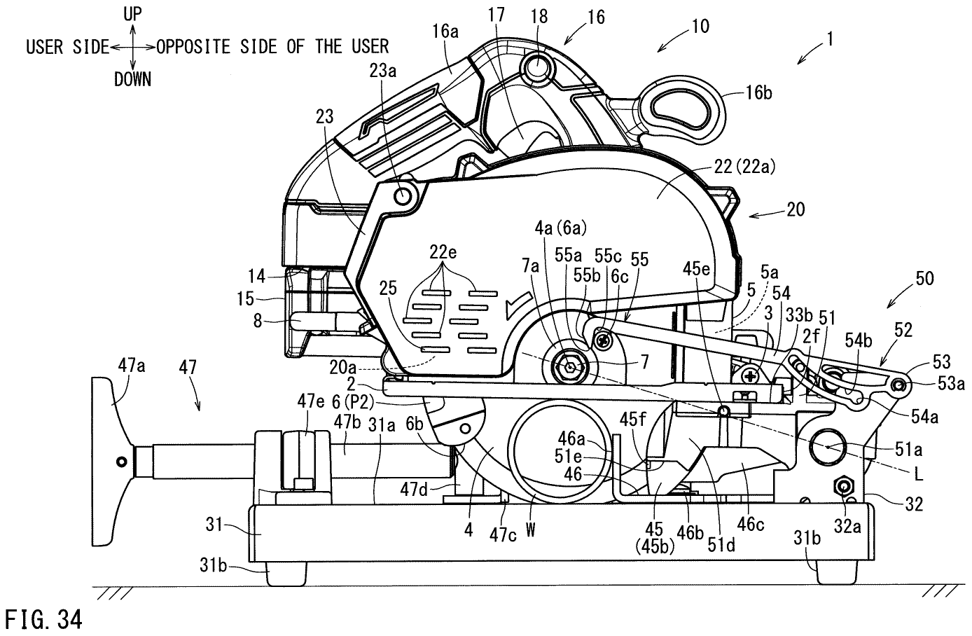

When the portable cutting device 1 moves a predetermined distance in the downward direction, the movable cover 6 exposes a part of the lower area of the cutting blade 4. This allows the cutting blade 4 to cut into the workpiece W (refer to FIG. 33). When the portable cutting device 1 moves downward to the bottom dead center, the movable cover 6 opens to the open position P2 where almost of the lower area of the cutting blade 4 is exposed (refer to FIG. 34). In this manner, the movable cover 6 can be opened and closed by the link arm 52 in conjunction with the swing movement of the portable cutting device 1 in the up-down direction.

As described above, the attachment arm 51 has the guide portion 51c that protrudes on a lateral side, as shown in FIGS. 29 to 34. The link arm 52 has the arm main body 54, the elongated hole 54a, and the contact portion 55b. The base portion 53 is connected to the end portion 55 via the arm main body 54. The elongated hole 54a is formed in the arm main body 54 for the guide portion 51c to be insertable to the elongated hole 54a and to guide the up-down movement of the guide portion 51c. The contact portion 55b is arranged in the adjoining area of the tip end edge 55a opposite to the base portion 53 and contacts the engaging portion 6c of the movable cover 6c. Accordingly, when the portable cutting device 1 moves to the opposite side of the user with respect to the attachment arm 51, the contact portion 55b of the link arm 52 slides against the engaging portion 6c of the movable cover 6 to move upward relative to the engaging portion 6c of the movable cover 6. At this time, the guide portion 51c can move within the elongated hole 54a in the up-down direction. Accordingly, the link arm 52 moves upward relative to the attachment arm 51. When the end portion 55 of the link arm 52 climbs over the engaging portion 6c of the movable cover 6, the end portion 55 of the link arm 52 moves downward to engage the engaging portion 6c of the movable cover 6. In this manner, the end portion 55 of the link arm 52 can smoothly engage the movable cover 6 in conjunction with the movement of the portable cutting device 1 toward the opposite side of the user.

As shown in FIGS. 30 to 34, when the base 2 of the portable cutting device 1 slides toward the opposite side of the user relative to the attachment arm 51, the elongated hole 54a and the contact portion 55b guide the link arm 52 in the upward direction. Accordingly, the elongated hole 54a moves relative to the guide portion 51c, and the contact portion 55b moves relative to the engaging portion 6c in conjunction with the slide movement of the base 2 of the portable cutting device 1 toward the opposite side of the user with respect to the attachment arm 51. Because of this configuration, the link arm 52 smoothly moves upward. Accordingly, the end portion 55 of the link arm 52 smoothly engages the movable cover 6.

As shown in FIGS. 29, 33, and 34, the attachment arm 51 has the guide portion 51c extending on the lateral side. The link arm 51 has the arm main body 54 and the elongated hole 54b for rotation. The base portion 53 is connected to the end portion 55 via the arm main body 54. The elongated hole 54b for rotation is formed in the arm main body 54 for the guide portion 51c to be insertable to the elongated hole 54b for rotation such that the elongated hole 54b for rotation guides the guide portion 51c in the up-down direction. Accordingly, the elongated holes 54b for rotation can guide the rotation of the link arm 52 in the up-down direction while the end portion 55 of the link arm 52 engages the movable cover 6. The link arm 52 rotates to move the movable cover 6 in the opening direction as the attachment arm 51 swings downward. In this manner, the movable cover 6 can be opened and closed in conjunction with the rotation of the attachment arm 51 in the up-down direction.

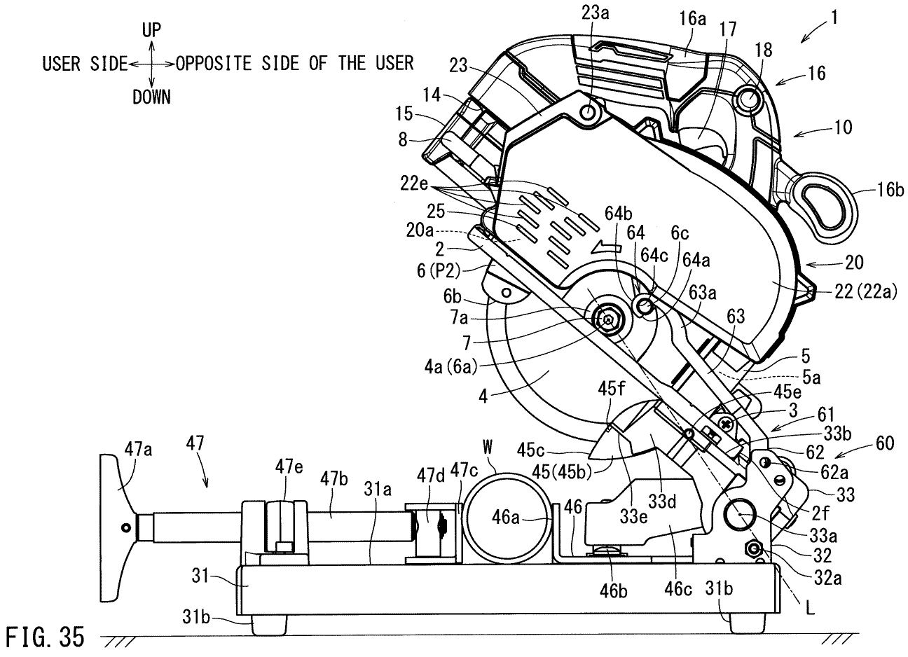

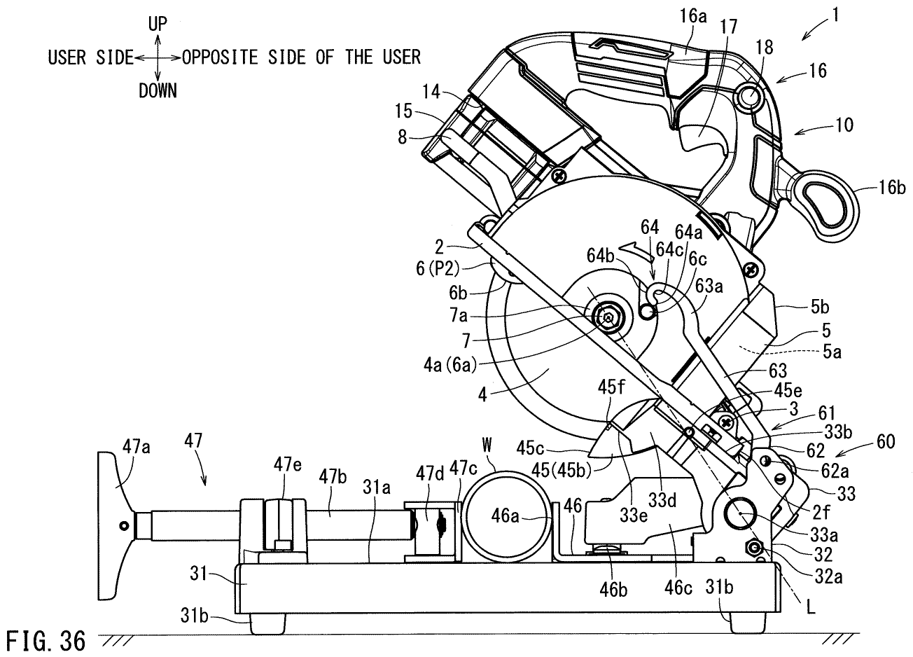

Next, a third embodiment of the present disclosure will be described with reference to FIGS. 35 and 36. A stand 60 for a portable cutting device 1 in the third embodiment has a link arm 61 instead of the link arm 34 of the stand 30 shown in FIG. 14. In the following description, only the numbers that differ from the first example will be mainly described in detail.

As shown in FIGS. 35 and 36, the link arm 61 is formed in the same structure as that of the link arm 34 (refer to FIG. 14). The link arm 61 releasably engages the movable cover 6. The link arm 61 is formed in a flat plate shape and includes a base 62, an arm main body 63, and an end portion 64. The link arm 61 is rotatably connected to the attachment arm 33. The rotation center 62a of the link arm 61 is positioned above an imaginary straight line L passing through the swing center 33a of the attachment arm 33 and the rotation center 6a of the movable cover 6, viewed from the left-right direction. The arm main body 63 extends straight from the base 62 to the user side in the adjoining arear of the rotation center 4a of the cutting blade 4. The arm main body 63 has an arc-shaped portion 63a that bends upward in an arc shape in the adjoining area of the rotation center 4a of the cutting blade 4. The arm main body 63 has an end portion 64 at the end of the arm main body 63 on the user side. The link arm 61 connects to the attachment arm 33. Accordingly, when the portable cutting device 1 swings in the up-down direction, the link arm 61 swings together with the portable cutting device 1. Because of this configuration, the movable cover 6 swings without an opening/closing movement of the movable cover 6. That is, the movable cover 6 remains open when the portable cutting device 1 swings in the up-down direction.

As shown in FIGS. 35 and 36, the end portion 64 is formed in a hook shape, bending downward toward the opposite side of the user in an arc shape. The end portion 64 engageably overlaps the engaging portion 6c of the movable cover 6 in the left-right direction. A contact portion 64b is formed in an arc shape extending to a tip end edge 64a on an outer circumferential side of the end portion 64. An inner circumferential portion 64c is formed in an arc shape on an inner circumferential side of the end portion 64. The engaging portion 6c can enter the inner circumferential portion 64c.

With reference to FIGS. 35 and 36, the following explains about an engagement of the link arm 61 with the movable cover 6. First, the base 2 of the portable cutting device 1 is attached to the attachment arm 33. The movable cover 6 is opened to the opening position P2 in a clockwise direction in FIGS. 35 and 36. The engaging portion 6c also moves in the clockwise direction around the rotation center 6a. At this time, the engaging portion 6c contacts the contact portion 64b, and accordingly, the link arm 61 does not engage the movable cover 6 yet (refer to FIG. 36). When the movable cover 6 is fully opened, the engaging portion 6c moves toward the opposite side of the user rather than the tip end edge 64a. The link arm 61 rotates downward and then the engaging portion 6c engages the link arm 61 on the inner circumferential portion 64c (refer to FIG. 35). The movable cover 6 remains open in the open position P2. Because of this configuration, the workpiece W can be cut by a swing movement of the portable cutting device 1 in the downward direction.

Various modifications can be made to the portable cutting device 1 and the stand 30, 50, and 60 in each of the embodiments described above. In the above embodiments, a metal cutter is illustrated as the portable cutting device 1. Instead, other portable cutting devices such as, for example, a portable circular saw with a removable dust box can be used as the portable cutting device 1. Further, without limiting the portable cutting device for cutting metal, other portable cutting devices such as, for example, a portable cutting device with a movable cover can be used as the portable cutting device 1. In the above embodiments, the portable cutting device 1 to which the battery 15 is detachably attached for serving as a power source is illustrated. Instead, a portable cutting device using an AC power source can be used. The present disclosure can be applied to any case where only a portable cutting device is provided, only a stand is provided, or a stationary cutting device, which has a portable cutting device and a stand, is provided as a product. The stand may be capable of mounting multiple types of portable cutting devices. The stand may have a structure that allows the portable cutting device to tilt in the left-right direction.

In the above embodiments, the inner plate 25 has a uniform thickness. Also, the air layer A has a uniform thickness. Instead, a change in the thickness of the inner plate 25 or the air layer A can optimize heat dissipation in each region. In the above embodiments, the second housing 22 is formed integrally with the rib 22b. Instead, a spacer that is separate from the second housing 22 may be arranged. Further, the surface properties, etc. of the inner plate 25 may be changed for each region.

In the above embodiments, both the front engaging portion 26 and the rear engaging portion 27 are arranged on the first side surface 21a. Instead, either one of the front engaging portion 26 and the rear engaging portion 27 may be arranged on the second side surface 22a. In the above embodiments, the rear side engaging portion 27 is used as the operation portion. Instead, the front engaging portion 26 may be used as the operation portion. In the above embodiments, the operation portion 27 is lever-shaped and operated to be pulled. Instead, for example, the operation portion 27 may be slide-operated by being pushed. In the above embodiments, the front engaging portion 26 is recessed and the front engaged portion 5c is convex. Instead, the front engaging portion 26 may be convex and the front engaged portion 5c may be recessed.

In the above embodiments, the protrusion 41 is a nut and the screw member 42 is a bolt. Instead, the protrusion 41 may be a bolt and the screw member 42 may be a nut. In the above embodiments, the sheet metal is placed on the arc-shaped surface 45a of the dust guide 45. Instead, the sheet metal may not be placed.

In the above embodiments, the link arms 34, 52, and 61 are formed in a plate shape as shown in the embodiments. Instead, the link arms 34, 52, and 61 may be formed, for example, in a rod shape or in a tubular shape. In the above embodiments, the link arms 34 and 52 open and close the movable cover 6 in conjunction with the movement of the portable cutting device 1 in the up-down direction. Instead, the opening and closing of the movable cover 6 may not be interlocked with the movement of the portable cutting device 1 in the up-down direction.

We claim:

1. A portable cutting device for cutting metal comprising:
a cutting device main body;
a cutting blade that is rotatably attachable to the cutting device main body; and
a dust box that is removably attachable to the cutting device main body, wherein the dust box comprises,
a first housing made of synthetic resin having a first side surface positioned inside of the cutting device main body,
a second housing made of synthetic resin having a second side surface positioned opposite the first side surface and interconnected with the first housing, and
an inner plate arranged through the second side surface and an air layer.

2. The portable cutting device according to claim 1, further comprising an upper opening formed in a dust collection chamber of the dust box and positioned between the first side surface of the first housing and the inner plate.

3. The portable cutting device according to claim 1, wherein the inner plate is made of aluminum.

4. The portable cutting device according to claim 1, wherein the inner plate has a uniform thickness.

5. The portable cutting device according to claim 1, wherein the inner plate has a thickness ranging from 0.3 mm to 1.0 mm.

6. The portable cutting device according to claim 1, wherein the inner plate is made of aluminum and has a surface having a low emissivity of 0.2 or less.

7. The portable cutting device according to claim 1, further comprising a spacer arranged between the inner plate and the second side surface of the second housing, wherein,
the spacer is formed integrally with the second housing or separate from the second housing.

8. The portable cutting device according to claim 7, wherein the spacer is a rib that is formed integrally with the second housing.

9. The portable cutting device according to claim 7, wherein the inner plate is configured to be pressed against the first housing by the spacer.

10. The portable cutting device according to claim 1, wherein the first housing, the second housing, and the inner plate are integrally assembled by screwing the second housing to the first housing.

11. The portable cutting device according to claim 10, a lower portion of the first housing and a lower portion of the second housing cooperate to form a bottom of a dust collection chamber of the dust box.

12. The portable cutting device according to claim 1, wherein the air layer is 0.5 mm or more in thickness.

13. The portable cutting device according to claim 1, further comprising a through hole that is configured to penetrate the second housing toward the air layer.

14. The portable cutting device according to claim 13, further comprising a front port situated at a front portion of the dust box for cutting dusts flowing into the dust box, wherein,
the through hole is positioned in a rear area of the second housing of the dust box and behind a rotation center of the cutting blade.

15. The portable cutting device according to claim 1, wherein the dust box further includes,
a front port situated at a front portion of the dust box for collecting cutting dusts,
a front engaging portion removably engageable with the cutting device main body in a left-right direction,
a rear engaging portion removably engageable with the cutting device main body in the left-right direction, and
an operation portion arranged either in the front engaging portion or the rear engaging portion, the operation portion configured to be disengagable from the cutting device main body by pushing the operation portion.

16. The portable cutting device according to claim 15, wherein either the front engaging portion or the rear engaging portion is arranged on the first side surface of the dust box.

17. The portable cutting device according to claim 16, wherein both the front engaging portion and the rear engaging portion are arranged on the first side surface of the dust box.

18. The portable cutting device according to claim 15, the rear engaging portion is the operation portion.

19. The portable cutting device according to claim 15, wherein,
the operation portion includes a pushable portion on an upper side of the operation portion and an engaging portion being engageable with the cutting device main body on a lower side of the operation portion, and
the pushable portion is integrally formed with the engaging portion.

20. The portable cutting device according to claim 15, wherein either one of the front engaging portion or an engaged portion of the cutting device main body which is engageable with the front engaging portion is convex and the other is concave.

21. The portable cutting device according to claim 15, wherein a distance between the front engaging portion and the rear engaging portion in a front-rear direction is larger than a half of a diameter of the cutting blade.
